(19) United States
(12) Patent Application Publication
(10) Pub. No.: US 2026/0304351 A1
(43) Pub. Date: Oct. 1, 2026

(54) OVER THE TOP POSITIONING COEXISTENCE

(71) Applicant: QUALCOMM Incorporated, San Diego, CA (US)

(72) Inventors: Mukesh KUMAR, Hyderabad (IN); Guttorm Ringstad OPSHAUG, Redwood City, CA (US); Pulkit RAJGADIYA, Hyderabad (IN)

(21) Appl. No.: 19/096,060

(22) Filed: Mar. 31, 2025

(51) Int. Cl. H04W 64/00; H04L 5/00; H04W 24/10

(52) U.S. Cl. CPC H04W 64/00; H04L 5/0051; H04W 24/10

(57) ABSTRACT

Disclosed are techniques for over-the-top (OTT) positioning. In an aspect, a user equipment may use priority rule information to measure downlink signals from a plurality of cells for an OTT positioning process. Prior to completion of the OTT positioning process, the user equipment may receive an indication of a modem activity to be performed at the UE. Prior to performing the modem activity, the user equipment may perform one or more positioning operations to generate a position fix based on the priority rule information.

### TECHNICAL FIELD

Aspects of the disclosure relate generally to wireless technologies.

### BACKGROUND

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide higher data rates as compared to previous standards, more accurate positioning (e.g., based on reference signals for positioning (RS-P), such as downlink, uplink, or sidelink positioning reference signals (PRS)), RF sensing, and other technical enhancements. These enhancements, as well as the use of higher frequency bands, enable improved RF sensing and 5G-based positioning.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of over-the-top (OTT) positioning at a user equipment (UE) includes using priority rule information to measure downlink signals from a plurality of cells for an OTT positioning process; prior to completion of the OTT positioning process, receiving an indication of a modem activity to be performed at the UE; and prior to performing the modem activity, performing one or more positioning operations to generate a position fix based on the priority rule information.

In an aspect, a method of over-the-top (OTT) positioning at an OTT server includes determining priority rule information for at least a first user equipment (UE) to measure downlink signals for an OTT positioning process; transmitting the priority rule information to the first UE; prior to completion of the OTT positioning process, receiving an indication of modem activity at the first UE; and generating or receiving a position fix based on the priority rule information prior to completion of the OTT positioning process.

In an aspect, a user equipment (UE) includes one or more memories; one or more transceivers; and one or more processors communicatively coupled to the one or more memories and the one or more transceivers, wherein the one or more processors, either alone or in combination, are configured to: measure downlink signals from a plurality of cells for an over-the-top (OTT) positioning process using priority rule information; prior to completion of the OTT positioning process, receive an indication of a modem activity to be performed at the UE; and prior to performing the modem activity, perform one or more positioning operations to generate a position fix based on the priority rule information.

In an aspect, an over-the-top (OTT) server includes one or more memories; one or more transceivers; and one or more processors communicatively coupled to the one or more memories and the one or more transceivers, wherein the one or more processors, either alone or in combination, are configured to: determine priority rule information for at least a first user equipment (UE) to measure downlink signals for an OTT positioning process; transmit, via the one or more transceivers, the priority rule information to the first UE; prior to completion of the OTT positioning process, receive an indication of modem activity at the first UE; and generate or receive a position fix based on the priority rule information prior to completion of the OTT positioning process.

In an aspect, a user equipment (UE) includes means for using priority rule information to measure downlink signals from a plurality of cells for an over-the-top (OTT) positioning process; means for receiving an indication of a modem activity to be performed at the UE prior to completion of the OTT positioning process; and means for performing one or more positioning operations to generate a position fix based on the priority rule information prior to performing the modem activity.

In an aspect, an over-the-top (OTT) server includes means for determining priority rule information for at least a first user equipment (UE) to measure downlink signals for an OTT positioning process; means for transmitting the priority rule information to the first UE; means for receiving an indication of modem activity at the first UE prior to completion of the OTT positioning process; and means for generating or receiving a position fix based on the priority rule information prior to completion of the OTT positioning process.

In an aspect, a non-transitory computer-readable medium stores computer-executable instructions that, when executed by a user equipment (UE), cause the user equipment to: use priority rule information to measure downlink signals from a plurality of cells for an over-the-top (OTT) positioning process; prior to completion of the OTT positioning process, receive an indication of a modem activity to be performed at the UE; and prior to performing the modem activity, perform one or more positioning operations to generate a position fix based on the priority rule information.

In an aspect, a non-transitory computer-readable medium stores computer-executable instructions that, when executed by an over-the-top (OTT) server, cause the OTT server to: determine priority rule information for at least a first UE to measure downlink signals for an OTT positioning process; transmit the priority rule information to the first user equipment (UE); prior to completion of the OTT positioning process, receive an indication of modem activity at the first UE; and generate or receive a position fix based on the priority rule information prior to completion of the OTT positioning process.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A, 2B, and 2C illustrate example wireless network structures, according to aspects of the disclosure.

FIGS. 3A, 3B, and 3C are simplified block diagrams of several sample aspects of components that may be employed in a user equipment (UE), a base station, and a network entity, respectively, and configured to support communications as taught herein.

FIG. 4 illustrates examples of various positioning methods supported in New Radio (NR), according to aspects of the disclosure.

FIG. 5 illustrates an example Long-Term Evolution (LTE) positioning protocol (LPP) capability transfer procedure, assistance data transfer procedure, and location information transfer procedure between a target device and a location server, according to aspects of the disclosure.

FIG. 6 is a diagram illustrating an example tracking reference signal (TRS) configuration, according to aspects of the disclosure.

FIG. 7 is a graph of an example channel energy response (CER) estimate, according to aspects of the disclosure.

FIG. 8 illustrates an example over-the-top (OTT)-based positioning procedure using tracking reference signals (TRS), according to aspects of the disclosure.

FIG. 9 illustrates bandwidth allocation for fifth generation (5G) New Radio (NR), according to aspects of the disclosure.

FIG. 10 illustrates twelve allowed TRS groups for Frequency Range 1 (FR1) of 5G NR, according to aspects of the disclosure.

FIG. 11 illustrates TRS-only resources, TRS or data resources, or data-only resources for three different operator designations, according to aspects of the disclosure.

FIG. 12 illustrates an example positioning process for performing OTT positioning, according to some aspects of the disclosure.

FIG. 13A illustrates crowdsourcing in an example OTT positioning environment, according to some aspects of the disclosure.

FIG. 13B illustrates an example OTT positioning configuration, according to some aspects of the disclosure.

FIGS. 14A, 14B, and 14C illustrate example TRS configurations for three different cells, according to some aspects of the disclosure.

FIGS. 15 and 16 illustrate example methods of OTT positioning, according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

Various aspects relate generally to over-the-top (OTT) positioning. Some aspects more specifically relate to priority rules for detecting downlink signals for OTT positioning to enhance coexistence between modem tasks and positioning. In some examples, the priority rules can be implemented to prevent a positioning process from being aborted or delayed if a higher priority modem activity is initiated at the UE by dynamic throttling of the positioning process to enable an early position fix. Even in the absence of a modem activity, the priority rules can enable faster completion of a positioning process, enabling more efficient positioning with lower power and resource use. In some examples, a UE can access priority rule information and use the priority rule information to search for downlink signals. The priority rule information may be provided by an OTT server, by the UE, or by a combination thereof.

Particular aspects of the subject matter described in this disclosure can be implemented to realize one or more of the following potential advantages. In some examples, by implementing priority rules the described techniques can be used to improve positioning reliability and efficiency, which can be of particular importance in use cases such as Industrial Internet of Things (IIoT) applications, robotics, and high precision device collaborations.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device, wearable (e.g., smartwatch, glasses, augmented reality (AR) / virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an uplink / reverse or downlink / forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

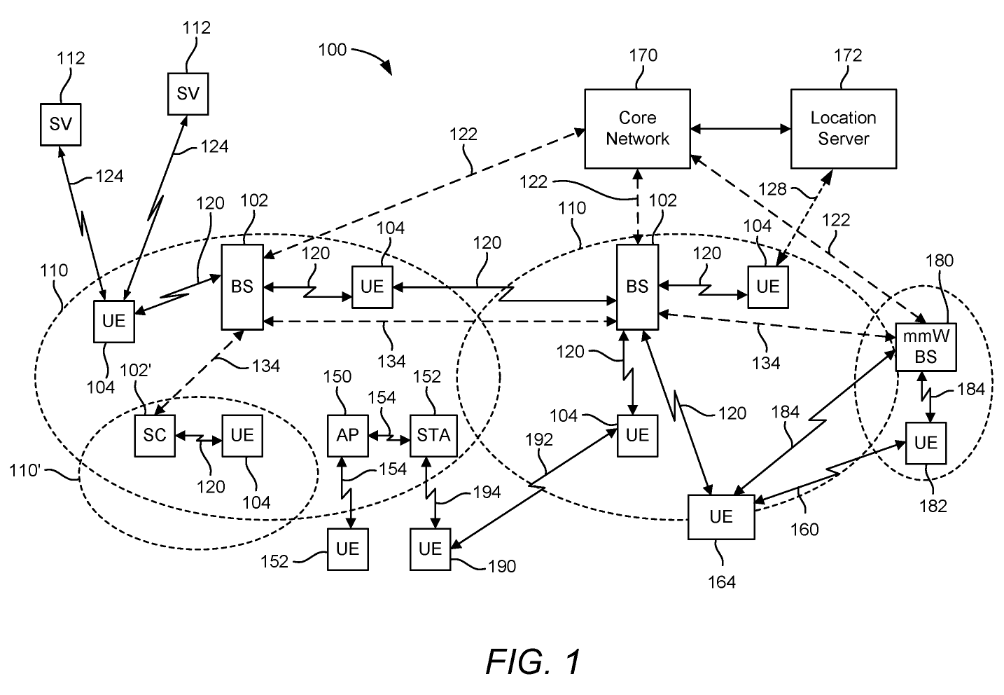

FIG. 1 illustrates an example wireless communications system 100, according to aspects of the disclosure. The wireless communications system 100 (which may also be referred to as a wireless wide area network (WWAN)) may include various base stations 102 (labeled “BS”) and various UEs 104. The base stations 102 may include macro cell base stations (high power cellular base stations) and/or small cell base stations (low power cellular base stations). In an aspect, the macro cell base stations may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., a location management function (LMF) or a secure user plane location (SUPL) location platform (SLP)). The location server(s) 172 may be part of core network 170 or may be external to core network 170. A location server 172 may be integrated with a base station 102. A UE 104 may communicate with a location server 172 directly or indirectly. For example, a UE 104 may communicate with a location server 172 via the base station 102 that is currently serving that UE 104. A UE 104 may also communicate with a location server 172 through another path, such as via an application server (not shown), via another network, such as via a wireless local area network (WLAN) access point (AP) (e.g., AP 150 described below), and so on. For signaling purposes, communication between a UE 104 and a location server 172 may be represented as an indirect connection (e.g., through the core network 170, etc.) or a direct connection (e.g., as shown via direct connection 128), with the intervening nodes (if any) omitted from a signaling diagram for clarity.

In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC / 5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102' (labeled “SC” for “small cell”) may have a geographic coverage area 110' that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102' may operate in a licensed and/or an unlicensed frequency spectrum. When operating in an unlicensed frequency spectrum, the small cell base station 102' may employ LTE or NR technology and use the same 5 GHz unlicensed frequency spectrum as used by the WLAN AP 150. The small cell base station 102', employing LTE / 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MULTEFIRE®.

The wireless communications system 100 may further include a millimeter wave (mmW) base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

The electromagnetic spectrum is often subdivided, based on frequency/wavelength, into various classes, bands, channels, etc. In 5G NR two initial operating bands have been identified as frequency range designations FR1 (410 MHz – 7.125 GHz) and FR2 (24.25 GHz – 52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz – 300 GHz) which is identified by the INTERNATIONAL TELECOMMUNICATION UNION® as a “millimeter wave” band.

The frequencies between FR1 and FR2 are often referred to as mid-band frequencies. Recent 5G NR studies have identified an operating band for these mid-band frequencies as frequency range designation FR3 (7.125 GHz – 24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz – 71 GHz), FR4 (52.6 GHz – 114.25 GHz), and FR5 (114.25 GHz – 300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency / component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

The wireless communications system 100 may further include a UE 164 that may communicate with a macro cell base station 102 over a communication link 120 and/or the mmW base station 180 over a mmW communication link 184. For example, the macro cell base station 102 may support a PCell and one or more SCells for the UE 164 and the mmW base station 180 may support one or more SCells for the UE 164.

In some cases, the UE 164 and the UE 182 may be capable of sidelink communication. Sidelink-capable UEs (SL-UEs) may communicate with base stations 102 over communication links 120 using the Uu interface (i.e., the air interface between a UE and a base station). SL-UEs (e.g., UE 164, UE 182) may also communicate directly with each other over a wireless sidelink 160 using the PC5 interface (i.e., the air interface between sidelink-capable UEs). A wireless sidelink (or just “sidelink”) is an adaptation of the core cellular (e.g., LTE, NR) standard that allows direct communication between two or more UEs without the communication needing to go through a base station. Sidelink communication may be unicast or multicast, and may be used for device-to-device (D2D) media-sharing, vehicle-to-vehicle (V2V) communication, vehicle-to-everything (V2X) communication (e.g., cellular V2X (cV2X) communication, enhanced V2X (eV2X) communication, etc.), emergency rescue applications, etc. One or more of a group of SL-UEs utilizing sidelink communications may be within the geographic coverage area 110 of a base station 102. Other SL-UEs in such a group may be outside the geographic coverage area 110 of a base station 102 or be otherwise unable to receive transmissions from a base station 102. In some cases, groups of SL-UEs communicating via sidelink communications may utilize a one-to-many (1:M) system in which each SL-UE transmits to every other SL-UE in the group. In some cases, a base station 102 facilitates the scheduling of resources for sidelink communications. In other cases, sidelink communications are carried out between SL-UEs without the involvement of a base station 102.

In an aspect, the sidelink 160 may operate over a wireless communication medium of interest, which may be shared with other wireless communications between other vehicles and/or infrastructure access points, as well as other RATs. A “medium” may be composed of one or more time, frequency, and/or space communication resources (e.g., encompassing one or more channels across one or more carriers) associated with wireless communication between one or more transmitter / receiver pairs. In an aspect, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by wireless local area network (WLAN) technologies, most notably IEEE 802.11x WLAN technologies generally referred to as “Wi-Fi.” Example systems of this type include different variants of CDMA systems, TDMA systems, FDMA systems, orthogonal FDMA (OFDMA) systems, single-carrier FDMA (SC-FDMA) systems, and so on.

Note that although FIG. 1 only illustrates two of the UEs as SL-UEs (i.e., UEs 164 and 182), any of the illustrated UEs may be SL-UEs. Further, although only UE 182 was described as being capable of beamforming, any of the illustrated UEs, including UE 164, may be capable of beamforming. Where SL-UEs are capable of beamforming, they may beamform towards each other (i.e., towards other SL-UEs), towards other UEs (e.g., UEs 104), towards base stations (e.g., base stations 102, 180, small cell 102’, access point 150), etc. Thus, in some cases, UEs 164 and 182 may utilize beamforming over sidelink 160.

In the example of FIG. 1, any of the illustrated UEs (shown in FIG. 1 as a single UE 104 for simplicity) may receive signals 124 from one or more Earth orbiting space vehicles (SVs) 112 (e.g., satellites). In an aspect, the SVs 112 may be part of a satellite positioning system that a UE 104 can use as an independent source of location information. A satellite positioning system typically includes a system of transmitters (e.g., SVs 112) positioned to enable receivers (e.g., UEs 104) to determine their location on or above the Earth based, at least in part, on positioning signals (e.g., signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In an aspect, SVs 112 may additionally or alternatively be part of one or more non-terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This element would in turn provide access to other elements in the 5G network and ultimately to entities external to the 5G network, such as Internet web servers and other user devices. In that way, a UE 104 may receive communication signals (e.g., signals 124) from an SV 112 instead of, or in addition to, communication signals from a terrestrial base station 102.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WI-FI DIRECT®, BLUETOOTH®, and so on.

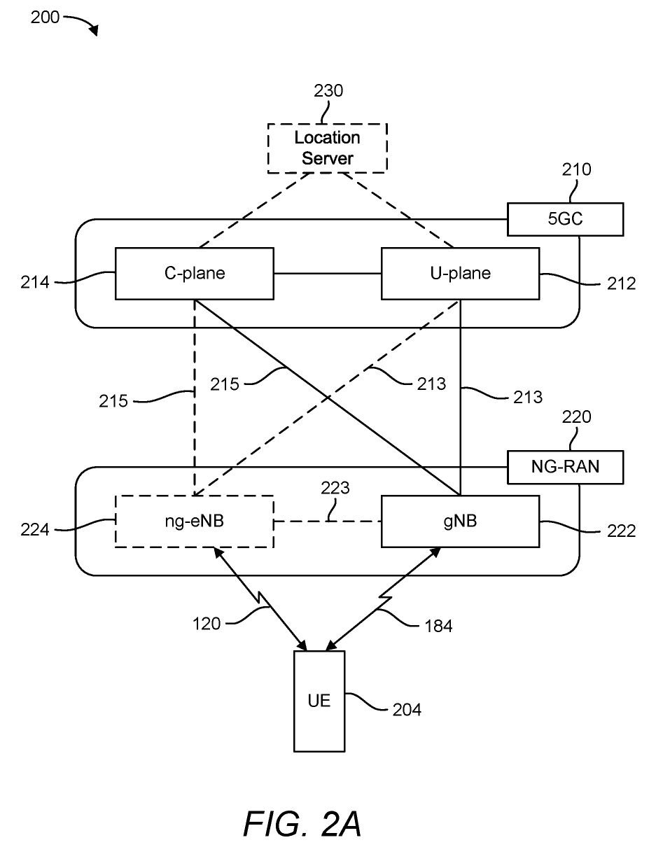

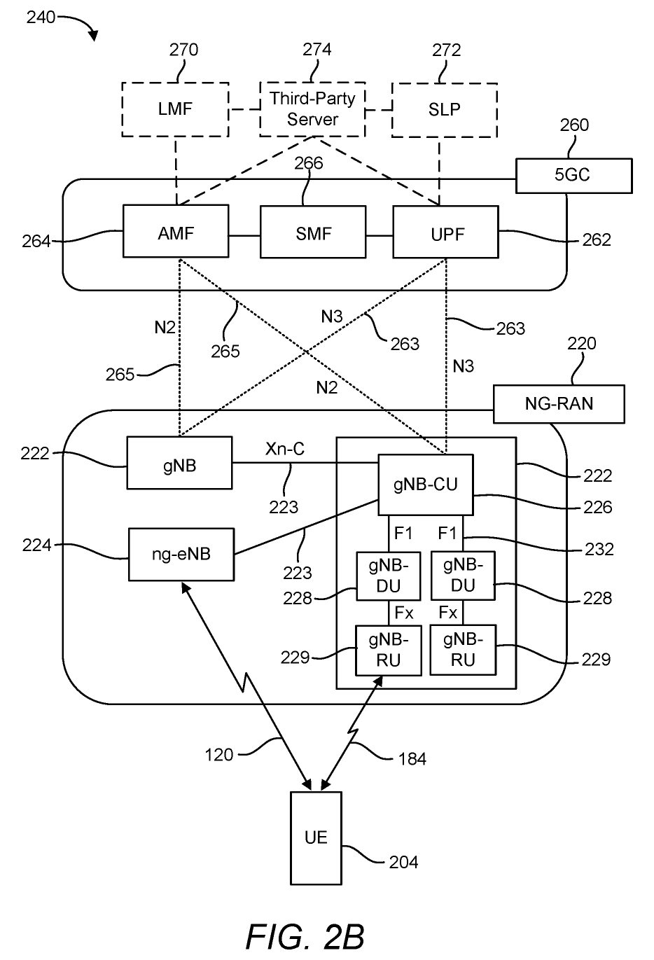

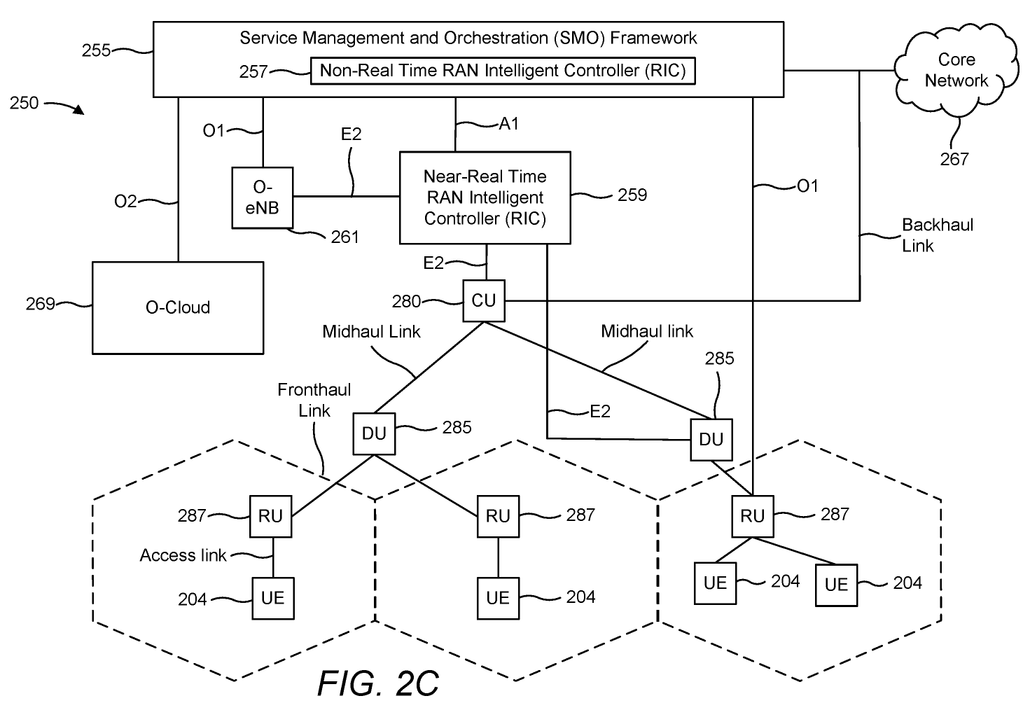

FIG. 2A illustrates an example wireless network structure 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-eNB 224 may communicate with one or more UEs 204 (e.g., any of the UEs described herein).

Another optional aspect may include a location server 230, which may be in communication with the 5GC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third party server, such as an original equipment manufacturer (OEM) server or service server).

FIG. 2B illustrates another example wireless network structure 240. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). The functions of the AMF 264 include registration management, connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP® (Third Generation Partnership Project) access networks.

Functions of the UPF 262 include acting as an anchor point for intra/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QoS) handling for the user plane (e.g., uplink/ downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (e.g., third-party server 274) over a user plane (e.g., using protocols intended to carry voice and/or data like the transmission control protocol (TCP) and/or IP).

Yet another optional aspect may include a third-party server 274, which may be in communication with the LMF 270, the SLP 272, the 5GC 260 (e.g., via the AMF 264 and/or the UPF 262), the NG-RAN 220, and/or the UE 204 to obtain location information (e.g., a location estimate) for the UE 204. As such, in some cases, the third-party server 274 may be referred to as a location services (LCS) client or an external client. The third-party server 274 can be implemented as a plurality of separate servers (e.g., physically separate servers, different software modules on a single server, different software modules spread across multiple physical servers, etc.), or alternately may each correspond to a single server.

User plane interface 263 and control plane interface 265 connect the 5GC 260, and specifically the UPF 262 and AMF 264, respectively, to one or more gNBs 222 and/or ng-eNBs 224 in the NG-RAN 220. The interface between gNB(s) 222 and/or ng-eNB(s) 224 and the AMF 264 is referred to as the “N2” interface, and the interface between gNB(s) 222 and/or ng-eNB(s) 224 and the UPF 262 is referred to as the “N3” interface. The gNB(s) 222 and/or ng-eNB(s) 224 of the NG-RAN 220 may communicate directly with each other via backhaul connections 223, referred to as the “Xn-C” interface. One or more of gNBs 222 and/or ng-eNBs 224 may communicate with one or more UEs 204 over a wireless interface, referred to as the “Uu” interface.

The functionality of a gNB 222 may be divided between a gNB central unit (gNB-CU) 226, one or more gNB distributed units (gNB-DUs) 228, and one or more gNB radio units (gNB-RUs) 229. A gNB-CU 226 is a logical node that includes the base station functions of transferring user data, mobility control, radio access network sharing, positioning, session management, and the like, except for those functions allocated exclusively to the gNB-DU(s) 228. More specifically, the gNB-CU 226 generally host the radio resource control (RRC), service data adaptation protocol (SDAP), and packet data convergence protocol (PDCP) protocols of the gNB 222. A gNB-DU 228 is a logical node that generally hosts the radio link control (RLC) and medium access control (MAC) layer of the gNB 222. Its operation is controlled by the gNB-CU 226. One gNB-DU 228 can support one or more cells, and one cell is supported by only one gNB-DU 228. The interface 232 between the gNB-CU 226 and the one or more gNB-DUs 228 is referred to as the “F1” interface. The physical (PHY) layer functionality of a gNB 222 is generally hosted by one or more standalone gNB-RUs 229 that perform functions such as power amplification and signal transmission/reception. The interface between a gNB-DU 228 and a gNB-RU 229 is referred to as the “Fx” interface. Thus, a UE 204 communicates with the gNB-CU 226 via the RRC, SDAP, and PDCP layers, with a gNB-DU 228 via the RLC and MAC layers, and with a gNB-RU 229 via the PHY layer.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station, or one or more units (or one or more components) performing base station functionality, may be implemented in an aggregated or disaggregated architecture. For example, a base station (such as a Node B (NB), evolved NB (eNB), NR base station, 5G NB, AP, TRP, cell, etc.) may be implemented as an aggregated base station (also known as a standalone base station or a monolithic base station) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN ALLIANCE®)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

FIG. 2C illustrates an example disaggregated base station architecture 250, according to aspects of the disclosure. The disaggregated base station architecture 250 may include one or more central units (CUs) 280 (e.g., gNB-CU 226) that can communicate directly with a core network 267 (e.g., 5GC 210, 5GC 260) via a backhaul link, or indirectly with the core network 267 through one or more disaggregated base station units (such as a Near-Real Time (Near-RT) RAN Intelligent Controller (RIC) 259 via an E2 link, or a Non-Real Time (Non-RT) RIC 257 associated with a Service Management and Orchestration (SMO) Framework 255, or both). A CU 280 may communicate with one or more DUs 285 (e.g., gNB-DUs 228) via respective midhaul links, such as an F1 interface. The DUs 285 may communicate with one or more radio units (RUs) 287 (e.g., gNB-RUs 229) via respective fronthaul links. The RUs 287 may communicate with respective UEs 204 via one or more radio frequency (RF) access links. In some implementations, the UE 204 may be simultaneously served by multiple RUs 287.

Each of the units, i.e., the CUs 280, the DUs 285, the RUs 287, as well as the Near-RT RICs 259, the Non-RT RICs 257 and the SMO Framework 255, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a RF transceiver), configured to receive or transmit signals, or both, over a wireless transmission medium to one or more of the other units.

In some aspects, the CU 280 may host one or more higher layer control functions. Such control functions can include RRC, PDCP, service data adaptation protocol (SDAP), or the like. Each control function can be implemented with an interface configured to communicate signals with other control functions hosted by the CU 280. The CU 280 may be configured to handle user plane functionality (i.e., Central Unit – User Plane (CU-UP)), control plane functionality (i.e., Central Unit – Control Plane (CU-CP)), or a combination thereof. In some implementations, the CU 280 can be logically split into one or more CU-UP units and one or more CU-CP units. The CU-UP unit can communicate bidirectionally with the CU-CP unit via an interface, such as the E1 interface when implemented in an O-RAN configuration. The CU 280 can be implemented to communicate with the DU 285, as necessary, for network control and signaling.

The DU 285 may correspond to a logical unit that includes one or more base station functions to control the operation of one or more RUs 287. In some aspects, the DU 285 may host one or more of a RLC layer, a MAC layer, and one or more high PHY layers (such as modules for forward error correction (FEC) encoding and decoding, scrambling, modulation and demodulation, or the like) depending, at least in part, on a functional split, such as those defined by the 3rd Generation Partnership Project (3GPP®). In some aspects, the DU 285 may further host one or more low PHY layers. Each layer (or module) can be implemented with an interface configured to communicate signals with other layers (and modules) hosted by the DU 285, or with the control functions hosted by the CU 280.

Lower-layer functionality can be implemented by one or more RUs 287. In some deployments, an RU 287, controlled by a DU 285, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 287 can be implemented to handle over the air (OTA) communication with one or more UEs 204. In some implementations, real-time and non-real-time aspects of control and user plane communication with the RU(s) 287 can be controlled by the corresponding DU 285. In some scenarios, this configuration can enable the DU(s) 285 and the CU 280 to be implemented in a cloud-based RAN architecture, such as a vRAN architecture.

The SMO Framework 255 may be configured to support RAN deployment and provisioning of non-virtualized and virtualized network elements. For non-virtualized network elements, the SMO Framework 255 may be configured to support the deployment of dedicated physical resources for RAN coverage requirements which may be managed via an operations and maintenance interface (such as an O1 interface). For virtualized network elements, the SMO Framework 255 may be configured to interact with a cloud computing platform (such as an open cloud (O-Cloud) 269) to perform network element life cycle management (such as to instantiate virtualized network elements) via a cloud computing platform interface (such as an O2 interface). Such virtualized network elements can include, but are not limited to, CUs 280, DUs 285, RUs 287 and Near-RT RICs 259. In some implementations, the SMO Framework 255 can communicate with a hardware aspect of a 4G RAN, such as an open eNB (O-eNB) 261, via an O1 interface. Additionally, in some implementations, the SMO Framework 255 can communicate directly with one or more RUs 287 via an O1 interface. The SMO Framework 255 also may include a Non-RT RIC 257 configured to support functionality of the SMO Framework 255.

The Non-RT RIC 257 may be configured to include a logical function that enables non-real-time control and optimization of RAN elements and resources, artificial intelligence/machine learning (AI/ML) workflows including model training and updates, or policy-based guidance of applications/features in the Near-RT RIC 259. The Non-RT RIC 257 may be coupled to or communicate with (such as via an A1 interface) the Near-RT RIC 259. The Near-RT RIC 259 may be configured to include a logical function that enables near-real-time control and optimization of RAN elements and resources via data collection and actions over an interface (such as via an E2 interface) connecting one or more CUs 280, one or more DUs 285, or both, as well as an O-eNB, with the Near-RT RIC 259.

In some implementations, to generate AI/ML models to be deployed in the Near-RT RIC 259, the Non-RT RIC 257 may receive parameters or external enrichment information from external servers. Such information may be utilized by the Near-RT RIC 259 and may be received at the SMO Framework 255 or the Non-RT RIC 257 from non-network data sources or from network functions. In some examples, the Non-RT RIC 257 or the Near-RT RIC 259 may be configured to tune RAN behavior or performance. For example, the Non-RT RIC 257 may monitor long-term trends and patterns for performance and employ AI/ML models to perform corrective actions through the SMO Framework 255 (such as reconfiguration via O1) or via creation of RAN management policies (such as A1 policies).

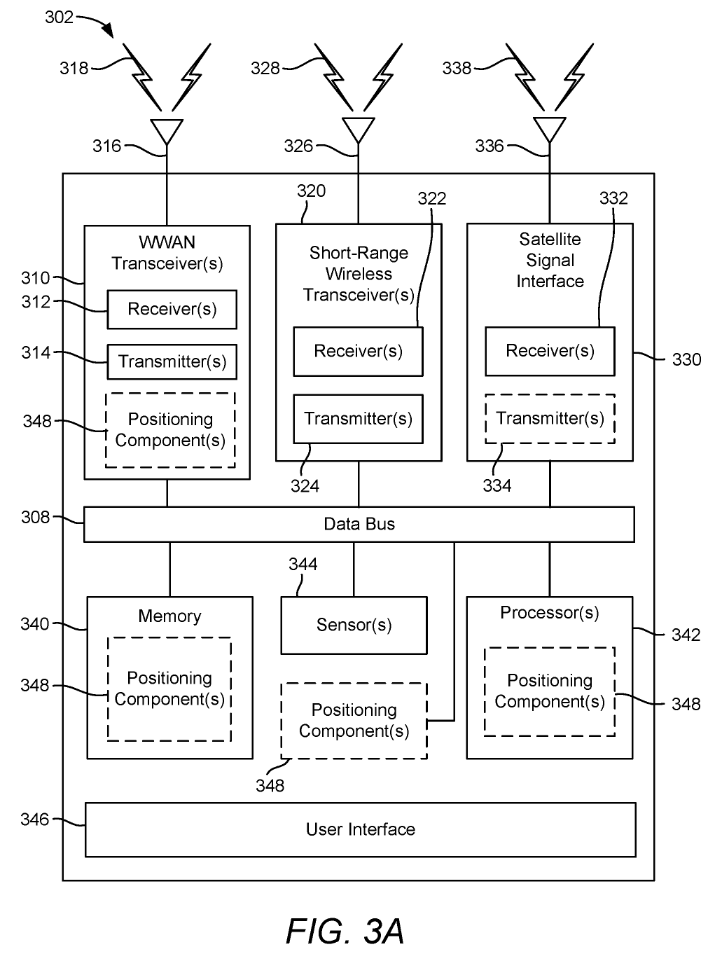

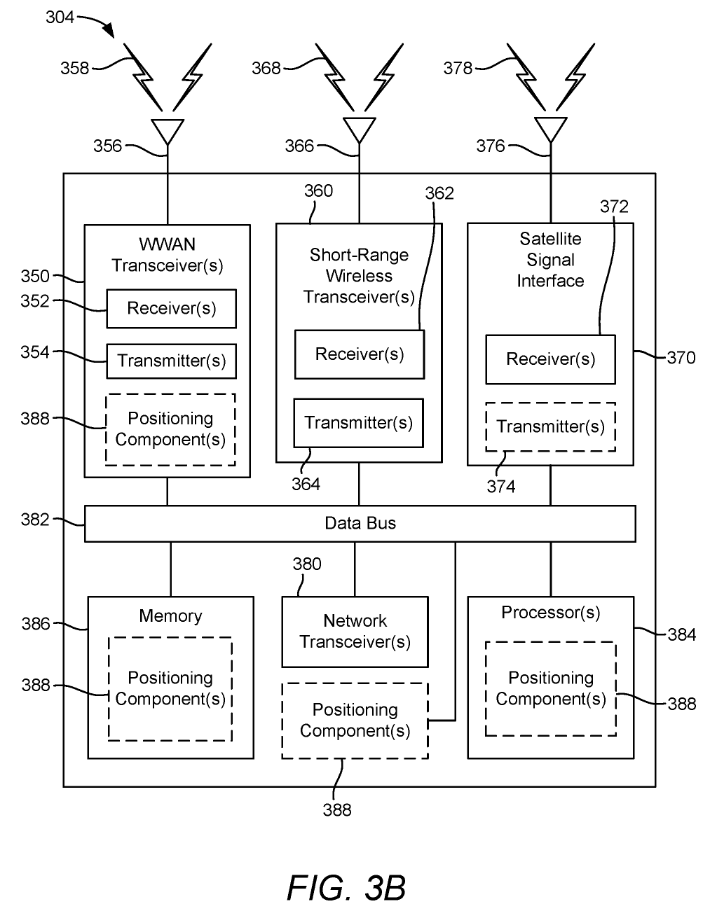

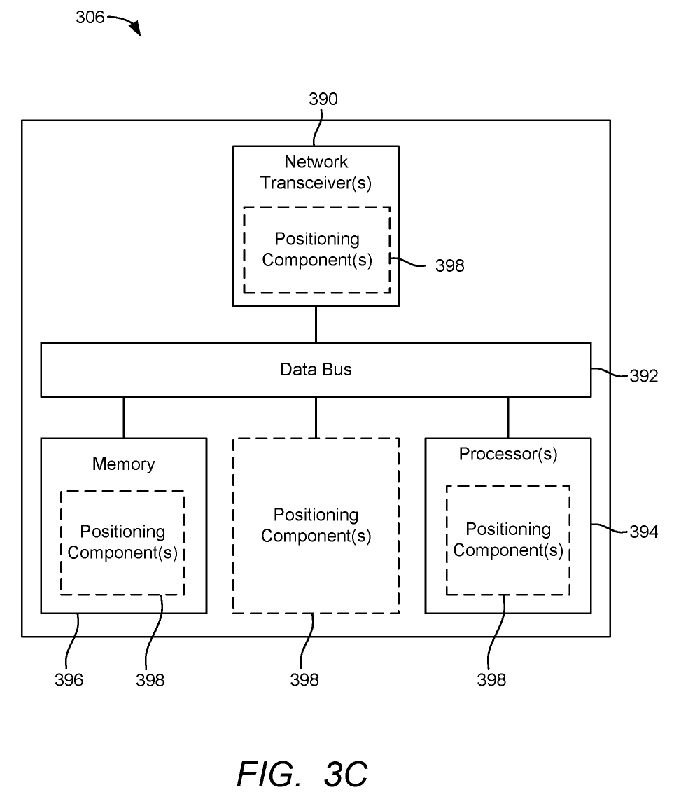

FIGS. 3A, 3B, and 3C illustrate several example components (represented by corresponding blocks) that may be incorporated into a UE 302 (which may correspond to any of the UEs described herein), a base station 304 (which may correspond to any of the base stations described herein), and a network entity 306 (which may correspond to or embody any of the network functions described herein; in particular, to an OTT server. For example, network entity 306 can correspond to the location server 230 and the LMF 270, or alternatively may be independent from the NG-RAN 220 and/or 5GC 210/260 infrastructure depicted in FIGS. 2A and 2B, such as a private network) to support the operations described herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include one or more wireless wide area network (WWAN) transceivers 310 and 350, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 310 and 350 may each be connected to one or more antennas 316 and 356, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and, conversely, for receiving and decoding signals 318 and 358 (e.g., messages, indications, information, pilots, and so on), respectively, in accordance with the designated RAT. Specifically, the WWAN transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 each also include, at least in some cases, one or more short-range wireless transceivers 320 and 360, respectively. The short-range wireless transceivers 320 and 360 may be connected to one or more antennas 326 and 366, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., Wi-Fi, LTE Direct, BLUETOOTH®, ZIGBEE®, Z-WAVE®, PC5, dedicated short-range communications (DSRC), wireless access for vehicular environments (WAVE), near-field communication (NFC), ultra-wideband (UWB), etc.) over a wireless communication medium of interest. The short-range wireless transceivers 320 and 360 may be variously configured for transmitting and encoding signals 328 and 368 (e.g., messages, indications, information, and so on), respectively, and, conversely, for receiving and decoding signals 328 and 368 (e.g., messages, indications, information, pilots, and so on), respectively, in accordance with the designated RAT. Specifically, the short-range wireless transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively. As specific examples, the short-range wireless transceivers 320 and 360 may be Wi-Fi transceivers, BLUETOOTH® transceivers, ZIGBEE® and/or Z-WAVE® transceivers, NFC transceivers, UWB transceivers, or vehicle-to-vehicle (V2V) and/or vehicle-to-everything (V2X) transceivers.

The UE 302 and the base station 304 also include, at least in some cases, satellite signal interfaces 330 and 370, which each include one or more satellite signal receivers 332 and 372, respectively, and may optionally include one or more satellite signal transmitters 334 and 374, respectively. In some cases, the base station 304 may be a terrestrial base station that may communicate with space vehicles (e.g., space vehicles 112) via the satellite signal interface 370. In other cases, the base station 304 may be a space vehicle (or other non-terrestrial entity) that uses the satellite signal interface 370 to communicate with terrestrial networks and/or other space vehicles.

The satellite signal receivers 332 and 372 may be connected to one or more antennas 336 and 376, respectively, and may provide means for receiving and/or measuring satellite positioning/communication signals 338 and 378, respectively. Where the satellite signal receiver(s) 332 and 372 are satellite positioning system receivers, the satellite positioning/communication signals 338 and 378 may be global positioning system (GPS) signals, global navigation satellite system (GLONASS) signals, Galileo signals, Beidou signals, Indian Regional Navigation Satellite System (NAVIC), Quasi-Zenith Satellite System (QZSS) signals, etc. Where the satellite signal receiver(s) 332 and 372 are non-terrestrial network (NTN) receivers, the satellite positioning/communication signals 338 and 378 may be communication signals (e.g., carrying control and/or user data) originating from a 5G network. The satellite signal receiver(s) 332 and 372 may comprise any suitable hardware and/or software for receiving and processing satellite positioning/communication signals 338 and 378, respectively. The satellite signal receiver(s) 332 and 372 may request information and operations as appropriate from the other systems, and, at least in some cases, perform calculations to determine locations of the UE 302 and the base station 304, respectively, using measurements obtained by any suitable satellite positioning system algorithm.

The optional satellite signal transmitter(s) 334 and 374, when present, may be connected to the one or more antennas 336 and 376, respectively, and may provide means for transmitting satellite positioning/communication signals 338 and 378, respectively. Where the satellite signal transmitter(s) 374 are satellite positioning system transmitters, the satellite positioning/communication signals 378 may be GPS signals, GLONASS® signals, Galileo signals, Beidou signals, NAVIC, QZSS signals, etc. Where the satellite signal transmitter(s) 334 and 374 are NTN transmitters, the satellite positioning/communication signals 338 and 378 may be communication signals (e.g., carrying control and/or user data) originating from a 5G network. The satellite signal transmitter(s) 334 and 374 may comprise any suitable hardware and/or software for transmitting satellite positioning/communication signals 338 and 378, respectively. The satellite signal transmitter(s) 334 and 374 may request information and operations as appropriate from the other systems.

The base station 304 and the network entity 306 each include one or more network transceivers 380 and 390, respectively, providing means for communicating (e.g., means for transmitting, means for receiving, etc.) with other network entities (e.g., other base stations 304, other network entities 306). For example, the base station 304 may employ the one or more network transceivers 380 to communicate with other base stations 304 or network entities 306 over one or more wired or wireless backhaul links. As another example, the network entity 306 may employ the one or more network transceivers 390 to communicate with one or more base station 304 over one or more wired or wireless backhaul links, or with other network entities 306 over one or more wired or wireless core network interfaces.

A transceiver may be configured to communicate over a wired or wireless link. A transceiver (whether a wired transceiver or a wireless transceiver) includes transmitter circuitry (e.g., transmitters 314, 324, 354, 364) and receiver circuitry (e.g., receivers 312, 322, 352, 362). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 380 and 390 in some implementations) may be coupled to one or more wired network interface ports. Wireless transmitter circuitry (e.g., transmitters 314, 324, 354, 364) may include or be coupled to a plurality of antennas (e.g., antennas 316, 326, 356, 366), such as an antenna array, that permits the respective apparatus (e.g., UE 302, base station 304) to perform transmit “beamforming,” as describedherein. Similarly, wireless receiver circuitry (e.g., receivers 312, 322, 352, 362) may include or be coupled to a plurality of antennas (e.g., antennas 316, 326, 356, 366), such as an antenna array, that permits the respective apparatus (e.g., UE 302, base station 304) to perform receive beamforming, as described herein. In an aspect, the transmitter circuitry and receiver circuitry may share the same plurality of antennas (e.g., antennas 316, 326, 356, 366), such that the respective apparatus can only receive or transmit at a given time, not both at the same time. A wireless transceiver (e.g., WWAN transceivers 310 and 350, short-range wireless transceivers 320 and 360) may also include a network listen module (NLM) or the like for performing various measurements.

As used herein, the various wireless transceivers (e.g., transceivers 310, 320, 350, and 360, and network transceivers 380 and 390 in some implementations) and wired transceivers (e.g., network transceivers 380 and 390 in some implementations) may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 302) and a base station (e.g., base station 304) will generally relate to signaling via a wireless transceiver.

The UE 302, the base station 304, and the network entity 306 also include other components that may be used in conjunction with the operations as disclosed herein. The UE 302, the base station 304, and the network entity 306 include one or more processors 342, 384, and 394, respectively, for providing functionality relating to, for example, wireless communication, and for providing other processing functionality. The processors 342, 384, and 394 may therefore provide means for processing, such as means for determining, means for calculating, means for receiving, means for transmitting, means for indicating, etc. In an aspect, the processors 342, 384, and 394 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 302, the base station 304, and the network entity 306 include memory circuitry implementing memories 340, 386, and 396 (e.g., each including a memory device), respectively, for maintaining information (e.g., information indicative of reserved resources, thresholds, parameters, and so on). The memories 340, 386, and 396 may therefore provide means for storing, means for retrieving, means for maintaining, etc. In some cases, the UE 302, the base station 304, and the network entity 306 may include positioning component(s) 348, 388, and 398, respectively. The positioning component(s) 348, 388, and 398 may be hardware circuits that are part of or coupled to the processors 342, 384, and 394, respectively, that, when executed, cause the UE 302, the base station 304, and the network entity 306 to perform the functionality described herein. In other aspects, the positioning component(s) 348, 388, and 398 may be external to the processors 342, 384, and 394 (e.g., part of a modem processing system, integrated with another processing system, etc.). Alternatively, the positioning component(s) 348, 388, and 398 may be memory modules stored in the memories 340, 386, and 396, respectively, that, when executed by the processors 342, 384, and 394 (or a modem processing system, another processing system, etc.), cause the UE 302, the base station 304, and the network entity 306 to perform the functionality described herein. FIG. 3A illustrates possible locations of the positioning component(s) 348, which may be, for example, part of the one or more WWAN transceivers 310, the memory 340, the one or more processors 342, or any combination thereof, or may be a standalone component. FIG. 3B illustrates possible locations of the positioning component(s) 388, which may be, for example, part of the one or more WWAN transceivers 350, the memory 386, the one or more processors 384, or any combination thereof, or may be a standalone component. FIG. 3C illustrates possible locations of the positioning component(s) 398, which may be, for example, part of the one or more network transceivers 390, the memory 396, the one or more processors 394, or any combination thereof, or may be a standalone component.

The UE 302 may include one or more sensors 344 coupled to the one or more processors 342 to provide means for sensing or detecting movement and/or orientation information that is independent of motion data derived from signals received by the one or more WWAN transceivers 310, the one or more short-range wireless transceivers 320, and/or the satellite signal interface 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in two-dimensional (2D) and/or three-dimensional (3D) coordinate systems.

In addition, the UE 302 includes a user interface 346 providing means for providing indications (e.g., audible and/or visual indications) to a user and/or for receiving user input (e.g., upon user actuation of a sensing device such a keypad, a touch screen, a microphone, and so on). Although not shown, the base station 304 and the network entity 306 may also include user interfaces.

Referring to the one or more processors 384 in more detail, in the downlink, IP packets from the network entity 306 may be provided to the processor 384. The one or more processors 384 may implement functionality for an RRC layer, a packet data convergence protocol (PDCP) layer, a radio link control (RLC) layer, and a medium access control (MAC) layer. The one or more processors 384 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer PDUs, error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate an RF carrier with a respective spatial stream for transmission.

At the UE 302, the receiver 312 receives a signal through its respective antenna(s) 316. The receiver 312 recovers information modulated onto an RF carrier and provides the information to the one or more processors 342. The transmitter 314 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the one or more processors 342, which implements Layer-3 (L3) and Layer-2 (L2) functionality.

In the downlink, the one or more processors 342 provides demultiplexing between transport and logical channels, packet reassembly, deciphering, header decompression, and control signal processing to recover IP packets from the core network. The one or more processors 342 are also responsible for error detection.

Similar to the functionality described in connection with the downlink transmission by the base station 304, the one or more processors 342 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the one or more processors 384.

In the uplink, the one or more processors 384 provides demultiplexing between transport and logical channels, packet reassembly, deciphering, header decompression, control signal processing to recover IP packets from the UE 302. IP packets from the one or more processors 384 may be provided to the core network. The one or more processors 384 are also responsible for error detection.

For convenience, the UE 302, the base station 304, and/or the network entity 306 are shown in FIGS. 3A, 3B, and 3C as including various components that may be configured according to the various examples described herein. It will be appreciated, however, that the illustrated components may have different functionality in different designs. In particular, various components in FIGS. 3A-3C are optional in alternative configurations and the various aspects include configurations that may vary due to design choice, costs, use of the device, or other considerations. For example, in case of FIG. 3A, a particular implementation of UE 302 may omit the WWAN transceiver(s) 310 (e.g., a wearable device or tablet computer or personal computer (PC) or laptop may have Wi-Fi and/or BLUETOOTH® capability without cellular capability), or may omit the short-range wireless transceiver(s) 320 (e.g., cellular-only, etc.), or may omit the satellite signal interface 330, or may omit the sensor(s) 344, and so on. In another example, in case of FIG. 3B, a particular implementation of the base station 304 may omit the WWAN transceiver(s) 350 (e.g., a Wi-Fi “hotspot” access point without cellular capability), or may omit the short-range wireless transceiver(s) 360 (e.g., cellular-only, etc.), or may omit the satellite signal interface 370, and so on. For brevity, illustration of the various alternative configurations is not provided herein, but would be readily understandable to one skilled in the art.

The various components of the UE 302, the base station 304, and the network entity 306 may be communicatively coupled to each other over data buses 308, 382, and 392, respectively. In an aspect, the data buses 308, 382, and 392 may form, or be part of, a communication interface of the UE 302, the base station 304, and the network entity 306, respectively. For example, where different logical entities are embodied in the same device (e.g., gNB and location server functionality incorporated into the same base station 304), the data buses 308, 382, and 392 may provide communication between them.

The components of FIGS. 3A, 3B, and 3C may be implemented in various ways. In some implementations, the components of FIGS. 3A, 3B, and 3C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 302 (e.g., by execution of appropriate code and/or by appropriate configuration of processor components). Similarly, some or all of the functionality represented by blocks 350 to 388 may be implemented by processor and memory component(s) of the base station 304 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE,” “by a base station,” “by a network entity,” etc. However, as will be appreciated, such operations, acts, and/or functions may actually be performed by specific components or combinations of components of the UE 302, base station 304, network entity 306, etc., such as the processors 342, 384, 394, the transceivers 310, 320, 350, and 360, the memories 340, 386, and 396, the positioning component(s) 348, 388, and 398, etc.

In some designs, the network entity 306 may be implemented as a core network component. In other designs, the network entity 306 may be distinct from a network operator or operation of the cellular network infrastructure (e.g., NG RAN 220 and/or 5GC 210/260). For example, the network entity 306 may be a component of a private network that may be configured to communicate with the UE 302 via the base station 304 or independently from the base station 304 (e.g., over a non-cellular communication link, such as Wi-Fi).

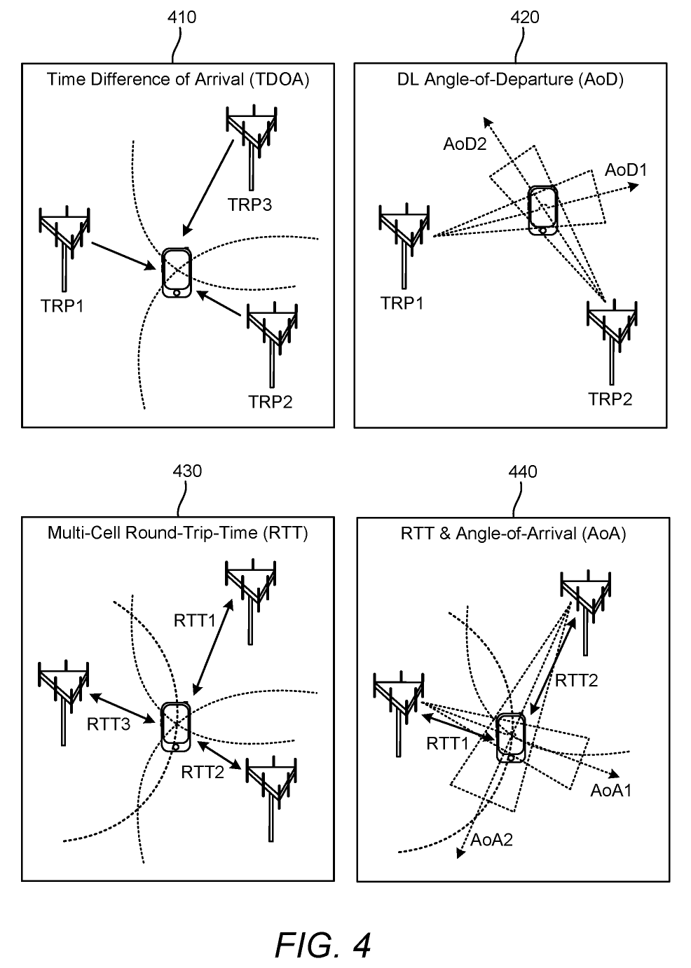

NR supports a number of cellular network-based positioning technologies, including downlink-based, uplink-based, and downlink-and-uplink-based positioning methods. Downlink-based positioning methods include observed time difference of arrival (OTDOA) in LTE, downlink time difference of arrival (DL-TDOA) in NR, and downlink angle-of-departure (DL-AoD) in NR. FIG. 4 illustrates examples of various positioning methods, according to aspects of the disclosure. In an OTDOA or DL-TDOA positioning procedure, illustrated by scenario 410, a UE measures the differences between the times of arrival (ToAs) of reference signals (e.g., positioning reference signals (PRS)) received from pairs of base stations, referred to as reference signal time difference (RSTD) or time difference of arrival (TDOA) measurements, and reports them to a positioning entity. More specifically, the UE receives the identifiers (IDs) of a reference base station (e.g., a serving base station) and multiple non-reference base stations in assistance data. The UE then measures the RSTD between the reference base station and each of the non-reference base stations. Based on the known locations of the involved base stations and the RSTD measurements, the positioning entity (e.g., the UE for UE-based positioning or a location server for UE-assisted positioning) can estimate the UE’s location.

For DL-AoD positioning, illustrated by scenario 420, the positioning entity uses a measurement report from the UE of received signal strength measurements of multiple downlink transmit beams to determine the angle(s) between the UE and the transmitting base station(s). The positioning entity can then estimate the location of the UE based on the determined angle(s) and the known location(s) of the transmitting base station(s).

Uplink-based positioning methods include uplink time difference of arrival (UL-TDOA) and uplink angle-of-arrival (UL-AoA). UL-TDOA is similar to DL-TDOA, but is based on uplink reference signals (e.g., sounding reference signals (SRS)) transmitted by the UE to multiple base stations. Specifically, a UE transmits one or more uplink reference signals that are measured by a reference base station and a plurality of non-reference base stations. Each base station then reports the reception time (referred to as the relative time of arrival (RTOA)) of the reference signal(s) to a positioning entity (e.g., a location server) that knows the locations and relative timing of the involved base stations. Based on the reception-to-reception (Rx-Rx) time difference between the reported RTOA of the reference base station and the reported RTOA of each non-reference base station, the known locations of the base stations, and their known timing offsets, the positioning entity can estimate the location of the UE using TDOA.

For UL-AoA positioning, one or more base stations measure the received signal strength of one or more uplink reference signals (e.g., SRS) received from a UE on one or more uplink receive beams. The positioning entity uses the signal strength measurements and the angle(s) of the receive beam(s) to determine the angle(s) between the UE and the base station(s). Based on the determined angle(s) and the known location(s) of the base station(s), the positioning entity can then estimate the location of the UE.

Downlink-and-uplink-based positioning methods include enhanced cell-ID (E-CID) positioning and multi-round-trip-time (RTT) positioning (also referred to as “multi-cell RTT” and “multi-RTT”). In an RTT procedure, a first entity (e.g., a base station or a UE) transmits a first RTT-related signal (e.g., a PRS or SRS) to a second entity (e.g., a UE or base station), which transmits a second RTT-related signal (e.g., an SRS or PRS) back to the first entity. Each entity measures the time difference between the time of arrival (ToA) of the received RTT-related signal and the transmission time of the transmitted RTT-related signal. This time difference is referred to as a reception-to-transmission (Rx-Tx) time difference. The Rx-Tx time difference measurement may be made, or may be adjusted, to include only a time difference between nearest slot boundaries for the received and transmitted signals. Both entities may then send their Rx-Tx time difference measurement to a location server (e.g., an LMF 270), which calculates the round trip propagation time (i.e., RTT) between the two entities from the two Rx-Tx time difference measurements (e.g., as the sum of the two Rx-Tx time difference measurements). Alternatively, one entity may send its Rx-Tx time difference measurement to the other entity, which then calculates the RTT. The distance between the two entities can be determined from the RTT and the known signal speed (e.g., the speed of light). For multi-RTT positioning, illustrated by scenario 430, a first entity (e.g., a UE or base station) performs an RTT positioning procedure with multiple second entities (e.g., multiple base stations or UEs) to enable the location of the first entity to be determined (e.g., using multilateration) based on distances to, and the known locations of, the second entities. RTT and multi-RTT methods can be combined with other positioning techniques, such as UL-AoA and DL-AoD, to improve location accuracy, as illustrated by scenario 440.

The E-CID positioning method is based on radio resource management (RRM) measurements. In E-CID, the UE reports the serving cell ID, the timing advance (TA), and the identifiers, estimated timing, and signal strength of detected neighbor base stations. The location of the UE is then estimated based on this information and the known locations of the base station(s).

To assist positioning operations, a location server (e.g., location server 230, LMF 270, SLP 272) may provide assistance data to the UE. For example, the assistance data may include identifiers of the base stations (or the cells/TRPs of the base stations) from which to measure reference signals, the reference signal configuration parameters (e.g., the number of consecutive slots including PRS, periodicity of the consecutive slots including PRS, muting sequence, frequency hopping sequence, reference signal identifier, reference signal bandwidth, etc.), and/or other parameters applicable to the particular positioning method. Alternatively, the assistance data may originate directly from the base stations themselves (e.g., in periodically broadcasted overhead messages, etc.). In some cases, the UE may be able to detect neighbor network nodes itself without the use of assistance data.

In the case of an OTDOA or DL-TDOA positioning procedure, the assistance data may further include an expected RSTD value and an associated uncertainty, or search window, around the expected RSTD. In some cases, the value range of the expected RSTD may be +/- 500 microseconds (µs). In some cases, when any of the resources used for the positioning measurement are in FR1, the value range for the uncertainty of the expected RSTD may be +/- 32 µs. In other cases, when all of the resources used for the positioning measurement(s) are in FR2, the value range for the uncertainty of the expected RSTD may be +/- 8 µs.

A location estimate may be referred to by other names, such as a position estimate, location, position, position fix, fix, or the like. A location estimate may be geodetic and comprise coordinates (e.g., latitude, longitude, and possibly altitude) or may be civic and comprise a street address, postal address, or some other verbal description of a location. A location estimate may further be defined relative to some other known location or defined in absolute terms (e.g., using latitude, longitude, and possibly altitude). A location estimate may include an expected error or uncertainty (e.g., by including an area or volume within which the location is expected to be included with some specified or default level of confidence).

Long-Term Evolution (LTE) positioning protocol (LPP) is used point-to-point between a location server (e.g., LMF 270) and a target device (e.g., a UE) in order to position the target device using position-related measurements obtained by one or more reference sources (physical entities or parts of physical entities that provide signals that can be measured by a target device in order to obtain the location of the target device). An LPP session is used between a location server and a target device in order to obtain location-related measurements or a location estimate or to transfer assistance data. Currently, a single LPP session is used to support a single location request and multiple LPP sessions can be used between the same endpoints to support multiple different location requests. Each LPP session comprises one or more LPP transactions (or procedures), with each LPP transaction performing a single operation (capability exchange, assistance data transfer, or location information transfer). Each LPP transaction involves the exchange of one or more LPP messages between the location server and the target device. The general format of an LPP message consists of a set of common fields followed by a body. The body (which may be empty) contains information specific to a particular message type. Each message type contains information specific to one or more positioning methods and/or information common to all positioning methods.

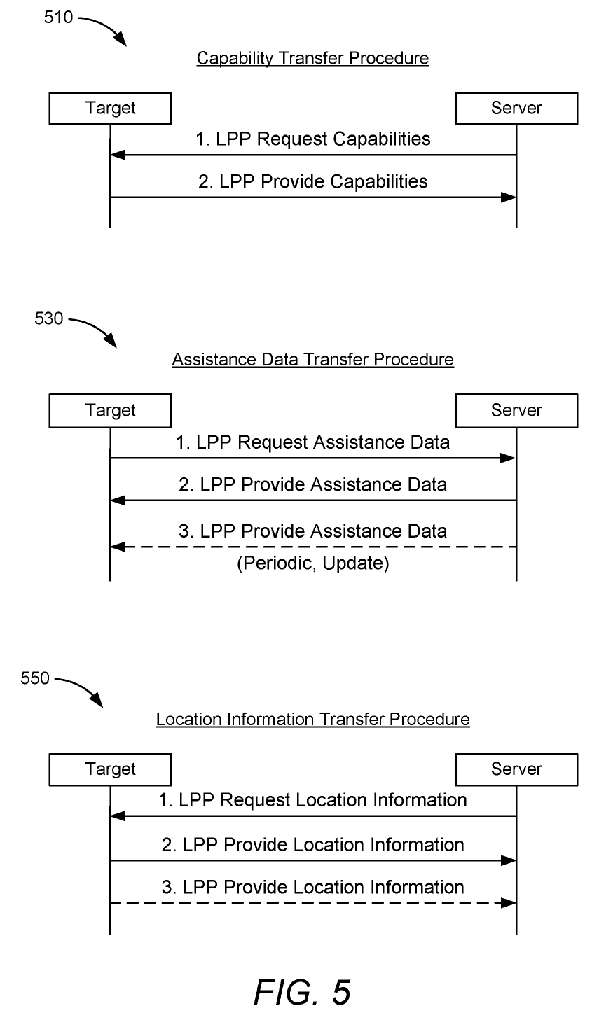

An LPP session generally includes at least a capability transfer or indication procedure, an assistance data transfer or delivery procedure, and a location information transfer or delivery procedure. FIG. 5 illustrates an example LPP capability transfer procedure 510, LPP assistance data transfer procedure 530, and LPP location information transfer procedure 550 between a target device (labeled “Target”) and a location server (labeled “Server”), according to aspects of the disclosure.

The purpose of an LPP capability transfer procedure 510 is to enable the transfer of capabilities from the target device (e.g., a UE 204) to the location server (e.g., an LMF 270). Capabilities in this context refer to positioning and protocol capabilities related to LPP and the positioning methods supported by LPP. In the LPP capability transfer procedure 510, the location server (e.g., an LMF 270) indicates the types of capabilities needed from the target device (e.g., UE 204) in an LPP Request Capabilities message. The target device responds with an LPP Provide Capabilities message. The capabilities included in the LPP Provide Capabilities message should correspond to any capability types specified in the LPP Request Capabilities message. Specifically, for each positioning method for which a request for capabilities is included in the LPP Request Capabilities message, if the target device supports this positioning method, the target device includes the capabilities of the target device for that supported positioning method in the LPP Provide Capabilities message. For an LPP capability indication procedure, the target device provides unsolicited (i.e., without receiving an LPP Request Capabilities message) capabilities to the location server in an LPP Provide Capabilities message.

The purpose of an LPP assistance data transfer procedure 530 is to enable the target device to request assistance data from the location server to assist in positioning, and to enable the location server to transfer assistance data to the target device in the absence of a request. In the LPP assistance data transfer procedure 530, the target device sends an LPP Request Assistance Data message to the location server. The location server responds to the target device with an LPP Provide Assistance Data message containing assistance data. The transferred assistance data should match or be a subset of the assistance data requested in the LPP Request Assistance Data. The location server may also provide any not requested information that it considers useful to the target device. The location server may also transmit one or more additional LPP Provide Assistance Data messages to the target device containing further assistance data. For an LPP assistance data delivery procedure, the location server provides unsolicited assistance data necessary for positioning. The assistance data may be provided periodically or non-periodically.

The purpose of an LPP location information transfer procedure 550 is to enable the location server to request location measurement data and/or a location estimate from the target device, and to enable the target device to transfer location measurement data and/or a location estimate to a location server in the absence of a request. In an LPP location information transfer procedure 550, the location server sends an LPP Request Location Information message to the target device to request location information, indicating the type of location information needed and potentially the associated QoS. The target device responds with an LPP Provide Location Information message to the location server to transfer location information. The location information transferred should match or be a subset of the location information requested by the LPP Request Location Information unless the location server explicitly allows additional location information. More specifically, if the requested information is compatible with the target device’s capabilities and configuration, the target device includes the requested information in an LPP Provide Location Information message. Otherwise, if the target device does not support one or more of the requested positioning methods, the target device continues to process the message as if it contained only information for the supported positioning methods and handles the signaling content of the unsupported positioning methods by LPP error detection. If requested by the LPP Request Lactation Information message, the target device sends additional LPP Provide Location Information messages to the location server to transfer additional location information. An LPP location information delivery procedure supports the delivery of positioning estimations based on unsolicited service.

LPP also defines procedures related to error indication for when a receiving endpoint (target device or location server) receives erroneous or unexpected data or detects that certain data are missing. Specifically, when a receiving endpoint determines that a received LPP message contains an error, it can return an Error message to the transmitting endpoint indicating the error or errors and discard the received/erroneous message. If the receiving endpoint is able to determine that the erroneous LPP message is an LPP Error or Abort Message, then the receiving endpoint discards the received message without returning an Error message to the transmitting endpoint.

LPP also defines procedures related to abort indication to allow a target device or location server to abort an ongoing procedure due to some unexpected event (e.g., cancellation of a location request by an LCS client). An Abort procedure can also be used to stop an ongoing procedure (e.g., periodic location reporting from the target device). In an Abort procedure, a first endpoint determines that procedure P must be aborted and sends an Abort message to a second endpoint carrying the transaction ID for procedure P. The second endpoint then aborts procedure P.

An over-the-top (OTT) server (a third-party server external to an operator’s cellular network) may perform positioning operations with one or more UEs, much like a location server (e.g., LMF 270), but without coordinating with a location server or any base stations to configure specific reference signal transmissions for the UE(s) to measure. Rather, the OTT server and UE(s) utilize reference signals already transmitted in cellular networks (e.g., 5G and/or LTE networks). This type of positioning, without coordination with a location server or base station, but rather, utilizing reference signals that are already scheduled to be transmitted to and measured by a connected UE, is referred to as “OTT-based positioning,” “OTT positioning,” and the like. The reference signals measured by the UE are referred to as “OTT reference signals,” “OTT signals,” and the like.

For example, TRS may be used for positioning purposes, such as OTT-based positioning. TRS are configured in each cell with their own time, frequency, and scrambling identifier (ID). It is mandatory for all UEs to support TRS reception, and all 5G networks are required to transmit TRS. However, a UE is only aware of the TRS configuration of its serving cell. In addition, the TRS in one cell may collide with data, TRS, or channel state information reference signals (CSI-RS) in neighboring cells.

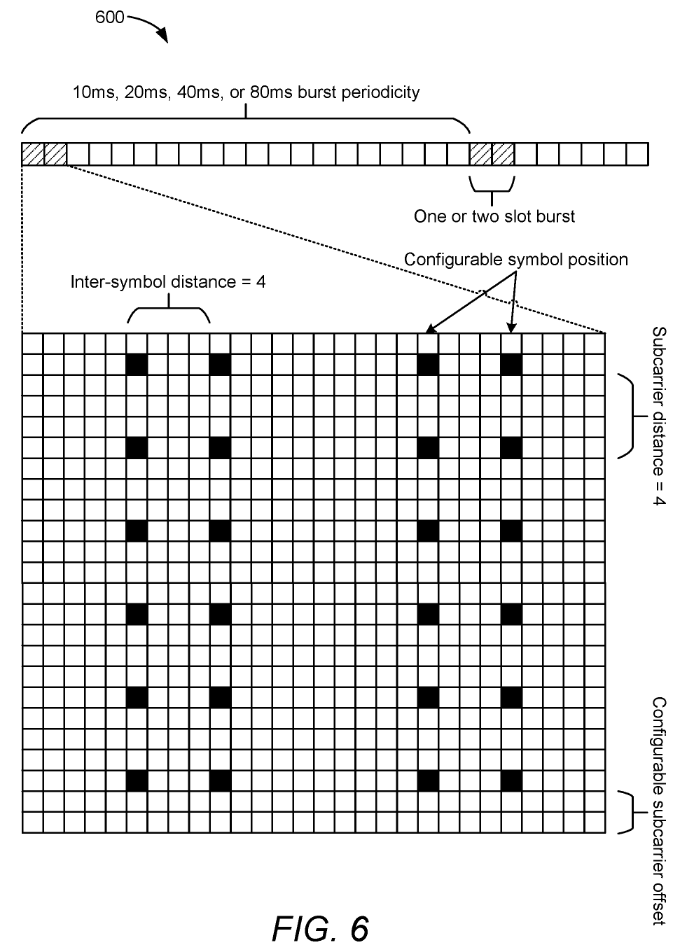

FIG. 6 is a diagram 600 illustrating an example TRS configuration, according to aspects of the disclosure. In FIG. 6, time is represented horizontally (on the X axis) with time increasing from left to right, while frequency is represented vertically (on the Y axis) with frequency increasing (or decreasing) from bottom to top. In the example of FIG. 6, two sequential slots are expanded to show the resource elements of four resource blocks making up the two slots.

As noted above, TRS is configured at each cell, with time and frequency resources, and a scrambling identifier (scrambling ID) that changes periodically (e.g., daily), and a UE is only aware of the TRS configuration of its serving cell. As shown in FIG. 6, TRS are transmitted in a burst of one or two slots with a periodicity of 10 ms, 20 ms, 40 ms, or 80 ms. Within a slot, the positions of the symbols carrying the TRS are configurable, provided there is a four-symbol inter-symbol distance between the TRS symbols. For FR1, the permitted symbol pair positions are (4, 8), (5, 9), and (6, 10). For FR2, all symbol pair positions within one slot are allowed. In the frequency domain, there is a fixed subcarrier distance between TRS subcarriers of four subcarriers. There is also a configurable subcarrier offset within each resource block. The TRS bandwidth may be equal to the device’s downlink bandwidth part (DL-BWP) (i.e., as large as 272 physical resource blocks (PRBs)) or 48 PRBs.

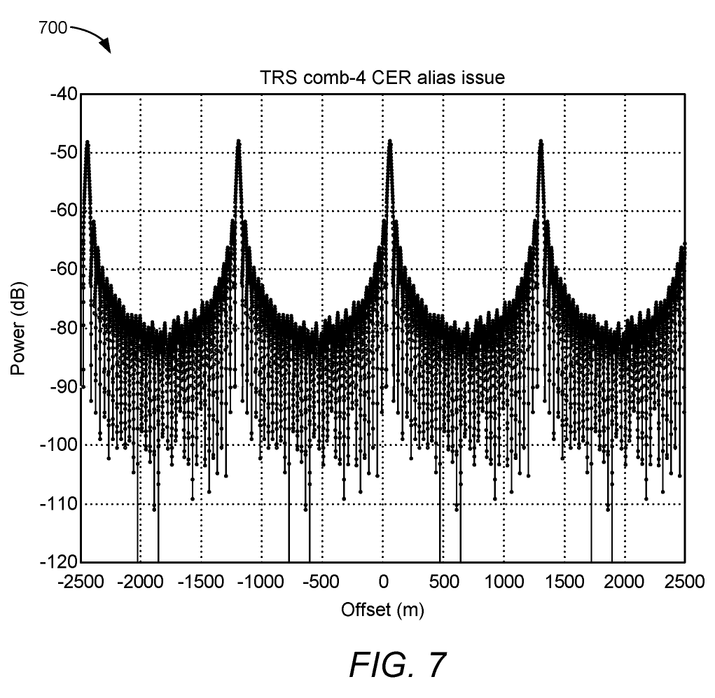

TRS are not fully staggered in the frequency domain (TRS are transmitted with a comb-4 comb pattern), and therefore, four peaks are expected to be observed in the channel estimate (e.g., channel energy response (CER)) of the TRS. More specifically, because TRS are transmitted on a given symbol with gaps in the frequency domain, it results in aliasing of the channel estimate. Aliasing is a result of converting the frequency domain to the time domain when estimating the channel estimate, and appears as multiple equally sized peaks, as shown in FIG. 7. Specifically, FIG. 7 is a graph 700 of a CER estimate for a single symbol. As shown in FIG. 7, the CER has four significant peaks, due to the TRS being transmitted with a comb-4 pattern (i.e., on every fourth subcarrier), but only one of these peaks is the “true” peak (i.e., represents the actual time of arrival (ToA) of the TRS in that symbol). However, because the TRS in a cell is quasi-co-located with the synchronization signal block (SSB) in the cell, the SSB can also be measured to solve the time-domain aliasing problem of the TRS in that cell.

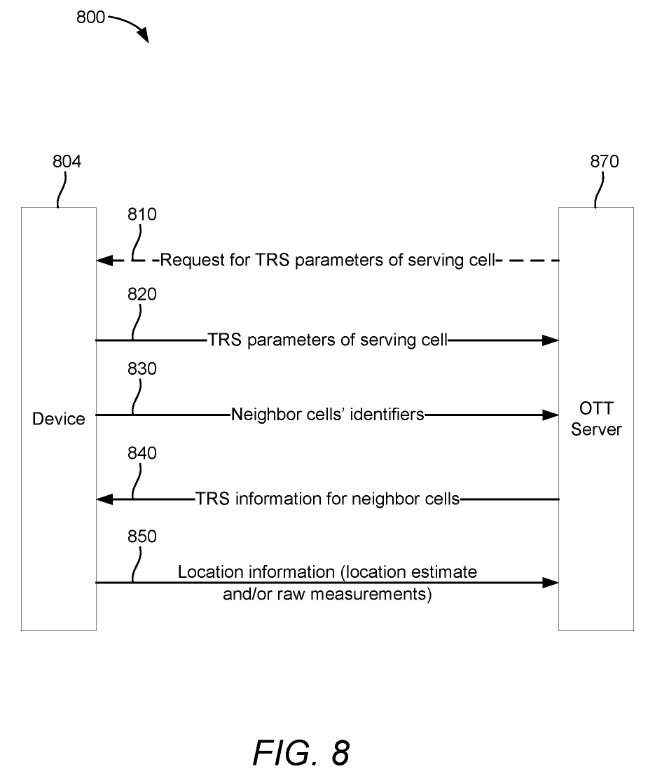

FIG. 8 illustrates an example over-the-top (OTT)-based positioning procedure 800 using tracking reference signals (TRS), according to aspects of the disclosure. The OTT-based positioning procedure 800 may be performed between a client device 804 (e.g., a mobile device, an IoT device, or any other type of UE) and an OTT server 870 (e.g., a third-party server, a connected intelligent edge (CIE) server, etc.).

At stage 810, the OTT server 870 optionally sends a request to a client device 804 to report TRS configuration parameters (e.g., symbol pattern, symbol offset, frequency offset, number of slots per burst, burst periodicity, scrambling identifier, quasi-co-location (QCL) relation, physical cell identifier (PCI), etc.) for the device’s 804 serving cell. The request may configure the device 804 to report the TRS configuration parameter periodically or when any change is determined. The request may also configure the device 804 to report only the TRS configuration for a subset of TRS detected by the device 804 based on certain criteria. For example, the request may configure the device 804 to only report the TRS configuration(s) for TRS having a signal strength above a threshold. The request may also configure the device 804 to only report TRS configurations associated to a specific component carrier, frequency band, or frequency range (e.g., FR1 and/or FR2). Further, the request may configure the device 804 to transition to a radio resource control (RRC) connected state for the purpose of gathering the TRS configuration parameters from the network.

At stage 820, the device 804 reports the requested TRS configuration parameters to the OTT server 870. Note that the device 804 may automatically report the TRS parameters of its serving cell without receiving a request from the OTT server 870 at stage 810, such as when changing serving cells or on a periodic basis.

At stage 830, the device 804 reports the identifiers (e.g., PCIs) of any neighbor cells that it discovered through, for example, radio resource management (RRM) procedures. The device 804 may also send reference signal received power (RSRP), reference signal received quality (RSRQ), signal-to-interference-plus-noise ratio (SINR), and/or received signal strength indication (RSSI) measurements associated with the PCIs of the neighbor cells. The report may include component carrier(s), frequency band(s), frequency range(s), slot offset(s), periodicity(ies), subframe-offset(s), time window(s), and/or preferred TRS configurations to be provided by the OTT server 870 (if available). These parameters can be reported in priority order.

Note that stages 820 and 830 may be a single transmission sequence or multiple transmission sequences. For example, the device 804 may transmit, and the OTT server 870 receive, both the serving cell information (e.g., the requested TRS configuration parameters) and the neighbor cell information (e.g., the identifiers of any neighbor cells) in the same data transmission (i.e., stages 820 and 830 are a single transmission sequence), or the device 804 may first transmit, and the OTT server 870 may first receive, the serving cell information and then the neighbor cell information (i.e., stages 820 and 830 are separate transmissions).

At stage 840, based on the identifiers of the neighbor cells, the OTT server 870 provides the TRS configuration for the identified neighbor cells to the device 804. The response may include one or more TRS configurations associated with a specific PCI and/or associated with synchronization signal blocks (SSBs) from that PCI. The multiple TRS configurations may be “alternatives” for the device 804 to attempt to detect. The response may also include timestamps, validity timers, expiration timers, or the like indicating when the provided configurations are valid.

In an aspect, the OTT server 870 may have obtained the TRS information for the neighbor cells based on performing stages 810 and 820 with multiple other devices, thereby creating a crowdsourced database of the TRS parameters of multiple cells. In some cases, where the OTT server 870 does not have the TRS information for a neighbor cell indicated at stage 840, it can send a request, as at stage 810, to another device 804 that is known to have that neighbor cell as its serving cell. The OTT server 870 can thereby obtain the TRS configuration parameters for that cell from the other device 804, as at stage 820.

At stage 850, the device 804 reports location information to the OTT server 870. For UE-based positioning, the location information may be the device’s 804 estimated location as determined from measurements of the TRS transmitted by the serving cell and the neighbor cells for which it received the TRS configuration information. Alternatively, or additionally, the location information may be the raw measurements of the TRS and the timestamps at which those measurements were obtained (as for UE-assisted positioning). The device 804 may also report which TRS were successfully detected, or which were not detected. That is, the device 804 may report the identifiers of the neighbor cells in which it detected or failed to detect the indicated TRS.

TRS based positioning is a timing-based positioning method, where a client device 804 measures the time of arrival (ToA) for serving cell and neighbor cells, and sends the measurements or the position to OTT server 870. ToA measurements are directly proportional to bandwidth of processing signals, so a 100 MHz signal will have better ToA accuracy compared to the 20 MHz signals.

As will be appreciated, while the foregoing has described using TRS for positioning, the OTT-based positioning procedure may instead be performed using other channel state information reference signals (CSI-RS), one or more signals from the synchronization signal block (SSB), or any other downlink reference signal specific to a serving cell or other access point. For example, cell-specific reference signals (CRS) may be used for 4G, while Long Training Sequence (LTS) signals may be used for WiFi networks.

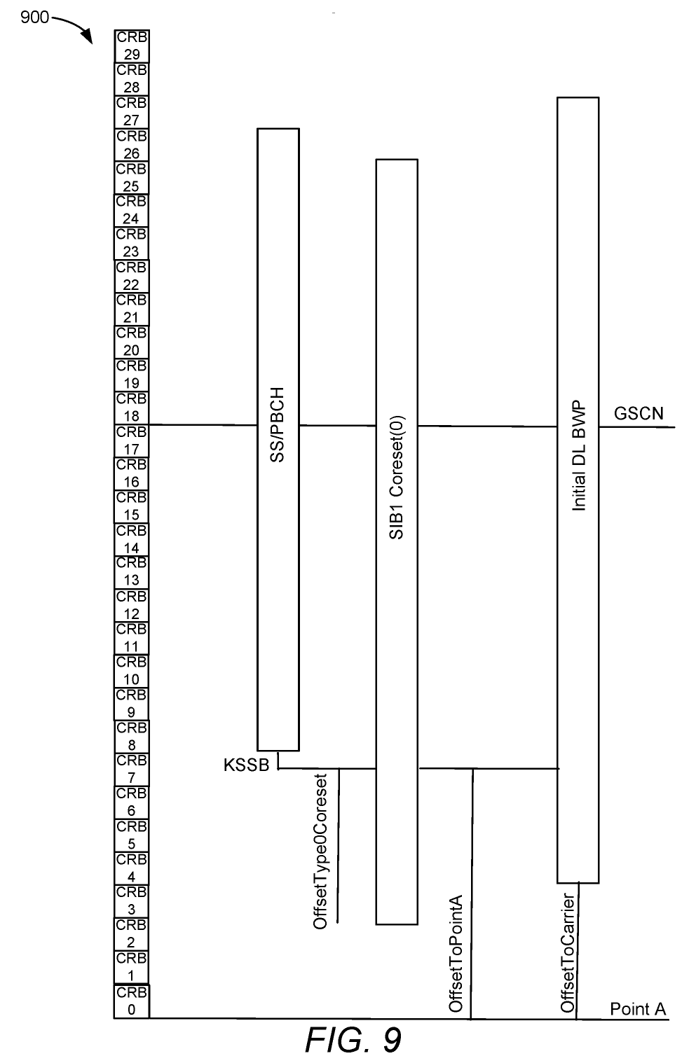

FIG. 9 illustrates an example bandwidth allocation 900 for 5G NR. 5G introduced the concept of bandwidth parts (BWPs), to save power by configuring multiple possible frequency ranges that can be used for uplink/downlink transmissions. In the example of FIG. 9, the common resource blocks (CRBs) 0 to 29 span the cell bandwidth, and Reference Point A corresponds to CRB 0. Frequency resources for the Synchronization Signal Physical Broadcast Channel (SS/PBCH) block, System Information Block 1 (SIB1) Coreset (0) and initial DL BWP may all be designated by offsets as shown, with the Global Synchronization Channel Number (GSCN) corresponding to the center frequency of the SS/PBCH block. According to some current protocols, up to four BWPs can be configured by the network, other than the initial BWP, with one BWP active at a time for uplink and downlink. The initial DL BWP may span a large portion of the cell bandwidth, as shown, while subsequently configured DL BWPs may have varying bandwidths and span different portions of the cell bandwidth.

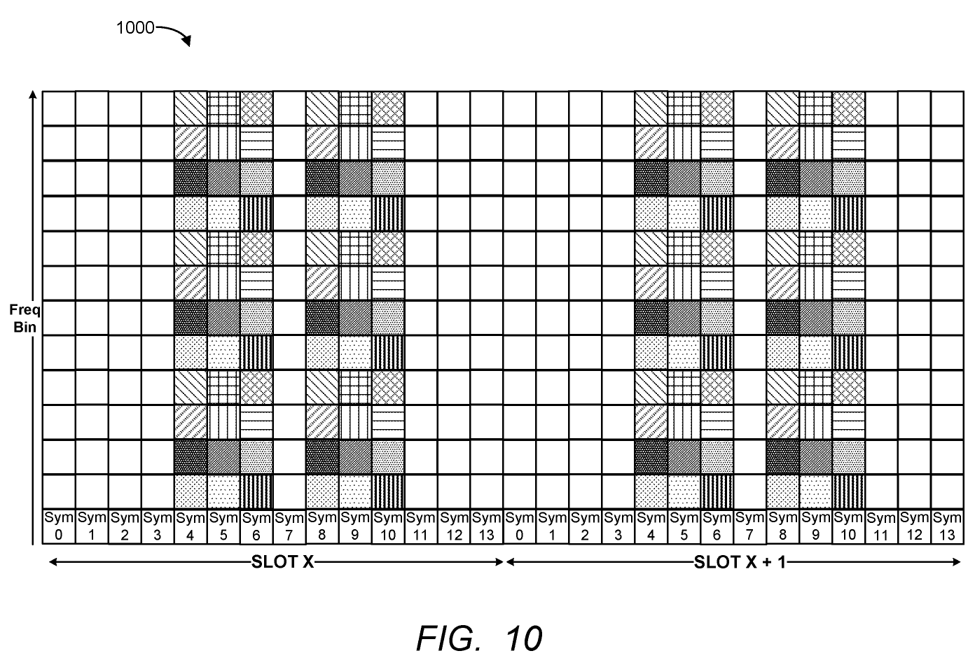

As noted above, according to current TRS implementation for FR1, TRS comb size is four, there are three different symbol configuration sets ((4,8), (5,9), and (6,10)) and four different frequency offsets (0, 1, 2, and 3). These correspond to twelve different TRS symbol and subcarrier options (referred to herein as TRS groups). The twelve TRS groups are illustrated in resource grid 1000 of FIG. 10, with each TRS group corresponding to a combination of symbol configuration and frequency offset represented by a different pattern of resource grid 1000. There are 1024 possible scrambling IDs, and TRS can be configured for either one or two slots (with FIG. 10 illustrating the two slot example). For a worst-case blind search, a UE would measure 12*1024 = 12,288 cell searches for each receive chain, with four receive chains in a typical deployment. Additionally, a UE generally supports interference cancellation stages (IC stages), with each cancelation stage on the order of 12,288 cells, and on the order of between two and five IC stages typically implemented. Therefore, TRS processing using blind searching and multiple IC stages can be time consuming and prone to interruption by modem processes, leading to OTT positioning abort or delay.

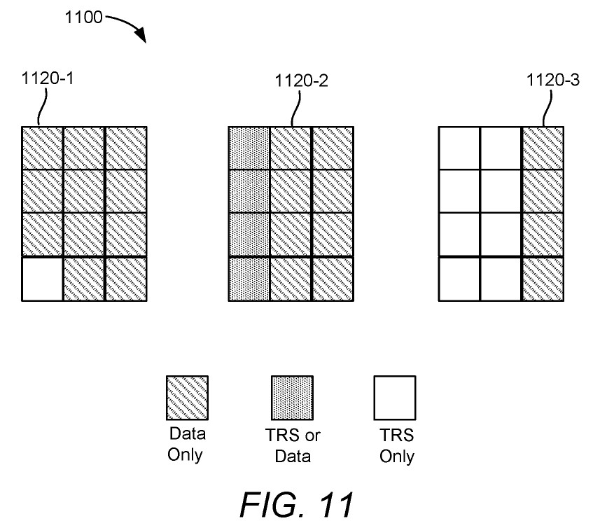

In some cases network operators have chosen particular TRS deployment strategies using a subset of the (currently) allowed TRS groups for TRS signaling, while using other allowed TRS groups for other signaling such as downlink data. FIG. 11 illustrates a configuration 1100 of TRS-only resources, TRS or data resources, or data-only resources allocated among the twelve allowed TRS groups for three example operator designations 1120-1, 1120-2, and 1120-3. In the first example, TRS is transmitted on only one of the twelve TRS groups currently allowable for FR1 (one symbol pair and one frequency offset), with the remainder reserved for downlink data transmission. In the second example, either TRS or downlink data can be transmitted on four of the twelve allowed TRS groups (one symbol pair and four frequency offsets), with the remainder reserved for downlink data transmission. In the third example, TRS can be transmitted on eight of the twelve allowed TRS groups (two symbol pairs and four frequency offsets), with the remaining TRS groups reserved for downlink data transmission. Note that data transmissions are not restricted to the same comb size etc. used for TRS transmissions.

The selected TRS deployment may pose particular challenges for OTT positioning. For example, there may be large data load variation on a slot by slot basis, with data loading measured per resource block. In some cases, interference cancellation may be needed to measure signals from weak neighbors, and one or two slots may be processed to combat data interference. For the example of operator 1120-1, TRS measurement may be interference cancellation limited, since a single group of the allowed FR1 TRS groups is used. For the example of operator 1120-2, TRS measurement may be interference limited, while for the example of operator 1120-3 may be propagation limited.

In general, OTT positioning uses UE measurement of downlink signaling and information indicative of anchor positioning (e.g., the latitude and longitude of a TRP transmitting the measured downlink signal) to generate position estimates. In some cases, the UE may perform position estimation using ToA or TDoA techniques, while in some cases the UE may transmit ToA or TDoA measurements and the associated transmitter information to one or more entities (e.g., an OTT server) to perform position estimation.

A UE performing OTT positioning with TRS will have access to TRS resource information for its serving cell, but may not have access to information for other cells needed to generate a position fix. For example, the UE and/or OTT server may have at least some access to TRS resource information for other nearby cells based on crowdsourcing (as described above), but in cases where up to date information is not available may need to do significant searching to generate a position fix.

For example, anchor locations and associated identifiers (e.g. cell IDs of TRPs in 4G and 5G, and Service Set Identifier (SSID) of AP in WiFi) are needed to associate signal measurements with the transmitting entity and arrival times with distance. The identifiers can be scrambled from time to time (e.g. once a day), making it difficult to know which anchor position corresponds to which measurement.

In some aspects, a mapping framework may be used to improve the performance of OTT positioning. In order to use downlink signal measurements (ToA/TDoA) to generate an estimated UE position (referred to as a position fix) with OTT positioning, the signal measurements need to be associated with the appropriate anchor positions (the location of the transmitter) and identifier. The mapping framework can be generated at the OTT server using crowdsourced information provided by the UE and/or other sources, where the crowdsourced information includes the anchor positions and the identifiers of the anchors. In order to generate a position fix for a positioning process, the UE measures downlink signals and uses the mapping framework to generate the position fix, or transmits the measurements and transmitter identifiers to the OTT server to use the mapping framework to generate the position fix.

Although OTT positioning provides positioning capability without the need for integrated access to scheduling and configuration for the cellular network, it can be challenging to generate a position estimate within time constraints posed by modem activity, particularly in circumstances where insufficient up-to-date TRS configuration information is available for the positioning process. In the example of a blind search, measuring downlink signals for an OTT position fix can be time consuming and particularly vulnerable to interruption by a higher priority modem task. In general, if a modem task is initiated while an OTT positioning process is in progress or planned, the positioning will be aborted or delayed in favor of the higher priority modem task. Examples of modem activity that may be prioritized over OTT positioning include one or more bandwidth part switching operations, one or more Radio Resource Control (RRC) reconfiguration operations, one or more handover operations, one or more emergency call operations, or combinations thereof.

OTT positioning may be particularly challenging for time-sensitive applications that use position information. Example applications that may need position information at specific times include some Industrial Internet of Things (IIoT) applications, robotics applications, and high precision device collaborations. Since OTT positioning may be aborted or delayed if a modem activity is scheduled while an OTT positioning process is ongoing or planned, the UE may fail to generate a timely positioning fix. Failure to generate a timely positioning result may degrade the performance of an application using location information, and the loss in performance may cause a failure in some time-sensitive applications.

In some current implementations, OTT positioning is based on best-effort, with modem tasks prioritized over positioning measurements. A UE generally provides OTT positioning information at a given periodicity, where the positioning information may include position fix(es) derived at the UE from signal measurements and/or information indicative of signal measurements that can be used by OTT server to derive the position fix(es). In response to an indication that high priority modem activity is scheduled/planned prior to initiation of a planned OTT positioning session (e.g., a periodic positioning session), the UE will delay the OTT positioning session in favor of the higher priority modem activity. In response to an indication that higher priority modem activity is initiated while OTT positioning is ongoing but prior to completion (generating a position fix), the UE will generally abort the positioning session until after completion of the modem activity.

Aspects of the current disclosure provide techniques to enhance coexistence between modem tasks and positioning, using dynamic throttling of an OTT positioning process. In some implementations, a UE accesses priority rule information for detecting downlink signals for an OTT positioning process and uses the priority rule information to search for downlink signals. If modem activity is initiated at the UE while the OTT positioning is ongoing (e.g., modem activity is scheduled or configured for one or more time resources prior to completion of the positioning process), measurements obtained prior to the scheduled modem activity can be used to generate an early position fix, as long as measurements from a minimum number of cells are obtained (e.g., measurements of TRS from the serving cell and two or more neighbor cells). As a result, an initiated modem task need not cause the positioning process to be aborted or delayed.

If no modem activity is initiated at the UE prior to completion of the position estimation (a position fix), the UE generates the position fix as usual; for example, by measuring downlink signals from a certain number of cells, by measuring downlink signals sufficient to obtain a position quality metric, etc. In this case, the priority rule information can reduce the power and processing resource consumption, enabling faster and more efficient positioning. Note that reference to measuring signals from a particular cell refers (for example) to receiving signals transmitted by a TRP of a base station supporting the cell.

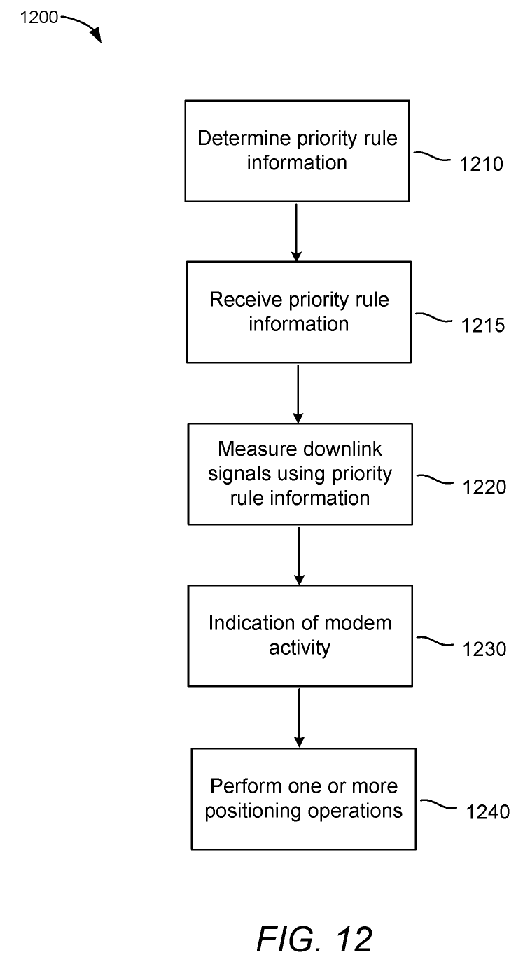

FIG. 12 shows an example positioning process 1200 for performing OTT positioning, according to some aspects of the disclosure. Process 1200 illustrates a case where the UE receives an indication of modem activity to be performed at the UE prior to completion of the positioning process. At 1210, a UE, an OTT server or both determine priority rule information to use in measurement of downlink signaling for an OTT positioning process. At 1215, in cases where a location server determines priority rule information, the UE receives priority rule information to use for OTT positioning (for example, in performing a search process to measure downlink signals from a plurality of cells). At 1220, the UE uses received priority rule information, priority rule information determined at the UE, or both to measure downlink signaling. In some cases where the OTT server computes the position fix, the UE transmits downlink signal measurements and indication of the associated transmitting cell to the OTT server in an ongoing manner, while in some cases the UE transmits the downlink signal measurements upon completion of the positioning process or in response to initiation of a modem activity.

At 1230, prior to the UE or OTT server generating a position fix to complete the OTT positioning process, the UE receives an indication of a modem activity to be performed at the UE. The indication may include, for example, scheduling/configuration for a modem activity such as one or more bandwidth part switching operations, one or more RRC reconfiguration operations, one or more handover operations, one or more emergency call operations, or a combination thereof. At 1240, the UE performs one or more positioning operations to generate an early position fix based on the priority rule information. The one or more positioning operations may include transmitting measurements of the downlink signals obtained using the priority rule information from a plurality of cells (e.g., ToA/TDoA measurements) and an identifier of an associated transmitter of the downlink signals to an OTT server to calculate a position fix, generating the position fix at the UE using measurements of the downlink signals obtained using the priority rule information from the plurality of cells and position information for an associated transmitter of the downlink signals for each of the plurality of cells, transmitting an indication that modem activity is to be performed at the UE to the OTT server, or a combination thereof. The indication that modem activity is to be performed at the UE may be explicit (e.g., a flag, field, or other explicit notification), or an implicit indication that a modem activity is to be performed at the UE (e.g., a request for calculation of an early position fix, an identification of the modem activity or its scheduling, etc.), or a combination thereof. Note that in cases where an OTT server computes the position fix, the UE may send at least some downlink signal measurements to the OTT server prior to the indication of the modem activity and the one or more positioning operations may include sending fewer than all downlink signal measurements and/or an indication that an early position fix is requested.

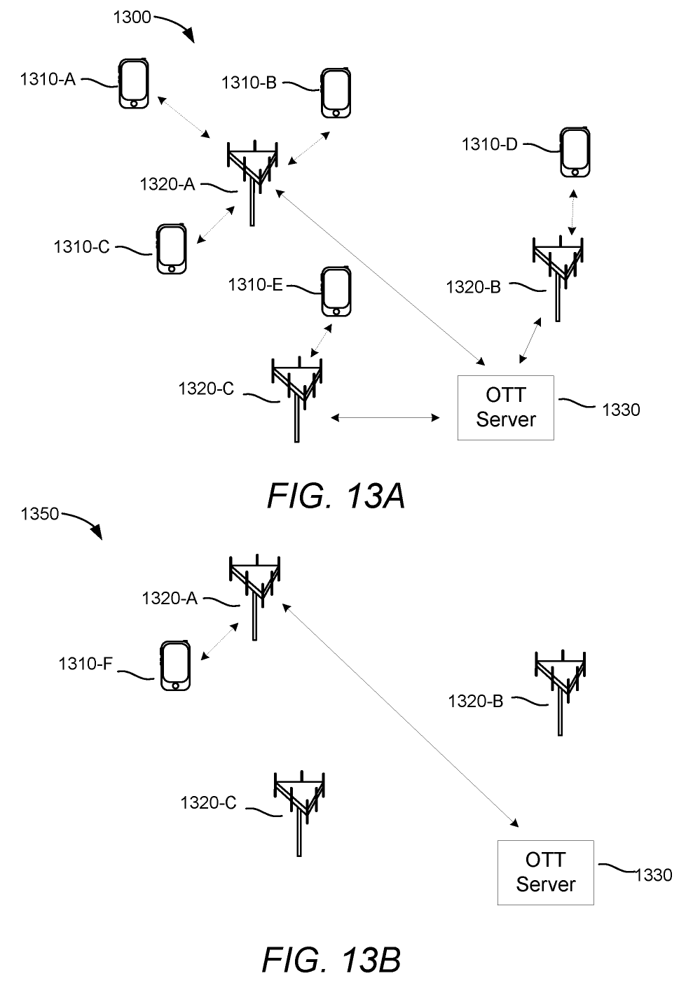

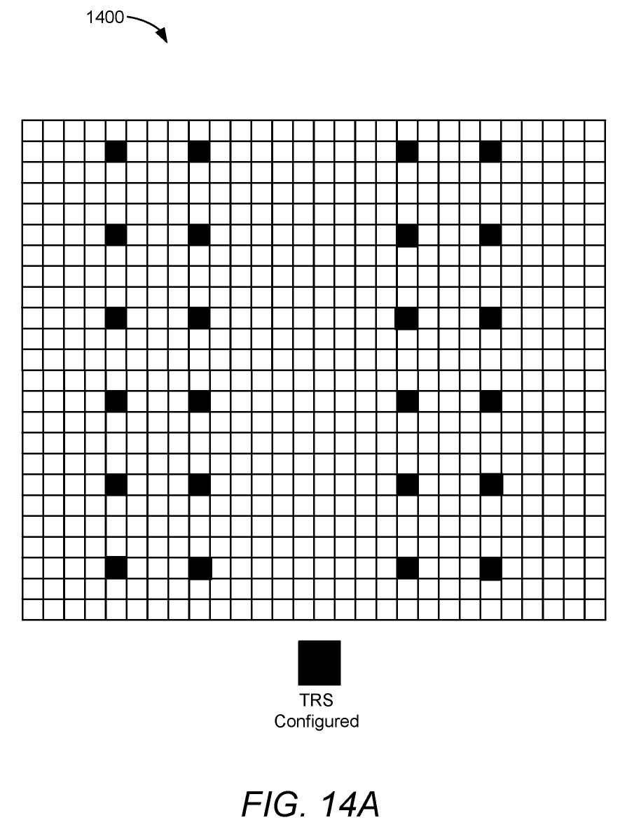

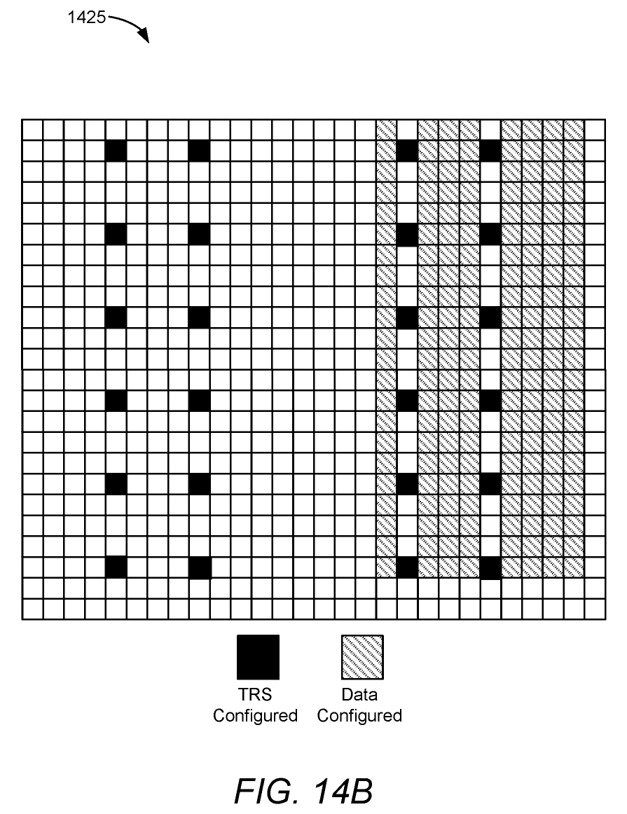

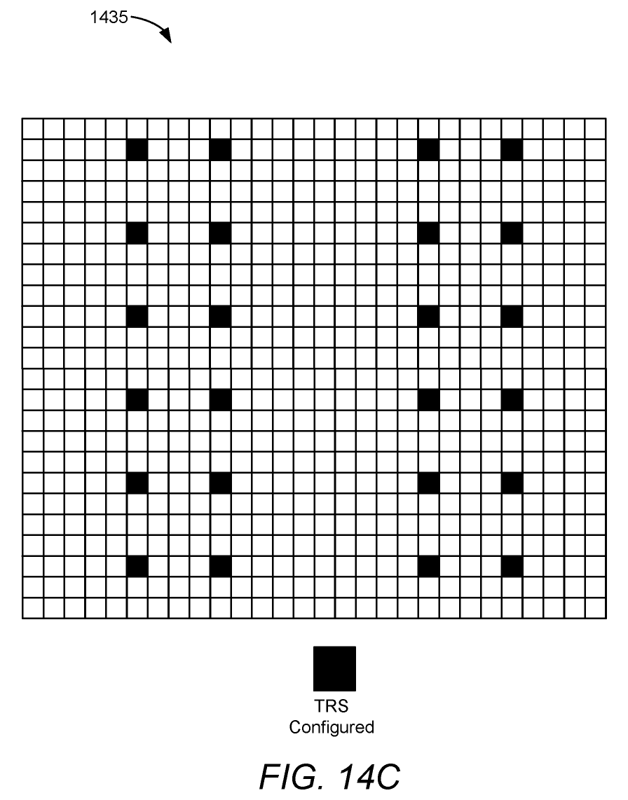

If a higher priority process such as a modem activity is not initiated at the UE prior to completion of the positioning process, a position fix is generated; for example, using the one or more priority rules as outlined herein. For example, the UE and OTT server may perform the acts described above at 1210, 1215, and 1220, and perform positioning operations to generate a position fix. For example, the UE can transmit ToA/TDoA measurements of the downlink signals with associated transmitter identifiers to the OTT server to use for calculation of the position fix, or can calculate the position fix using downlink signal measurements and transmitter locations and transmit the position fix to the OTT server. The techniques described herein can provide faster and less resource intensive positioning using one or more priority rules, even in cases where no modem activity is initiated during the positioning process. For example, a UE can generate and/or receive priority rule information and use the priority rule information for a positioning process and generate a position fix (or series of position fixes) with enhanced efficiency. The priority rule information may include a TRS group priority list, receive chain priority list, cell priority list, indication of one or more slot hypotheses, previous measurement information, variability information, previous or current configuration information, LOS/NLOS information, multipath information, Doppler information, etc., or combinations thereof. Combinations of priority rules may provide particular benefits in some situations; for example, in the example described below in FIGS. 13A-14C, where a combination of TRS group and slot hypothesis priority rules can mitigate the possibility of interference from data transmission from one or more neighbor cells.

Priority rules may be determined based on a number of factors. For example, an OTT server can base the priority rules on crowdsourced information, such as downlink signal configuration from the UE and/or other UEs at or near the current location of the UE. In another example, the OTT server may have knowledge of downlink signal configurations of some or all of the neighbor cells/gNBs. The OTT server may also use data loading information (e.g., a data loading profile) for some or all of the proximate gNBs, dilution of precision (DOP) information for a set of gNBs/TRPs (e.g., an indication of the geometric arrangement of TRPs in an area, with larger angular dispersion and shorter distance to TRPs associated with better positioning and lower DOP), multipath information such as multipath profile characteristics of some or all of the gNBs/TRPs, and line of sight (LOS) versus non-line of sight (NLOS) information/characteristics of some or all of the gNBs/TRPs, etc. Similarly, the UE can base the priority rules on a previous history of measurements, consistency/variability of measurements, LOS versus NLOS factor calculation for some or all of the gNBs/TRPs, multipath factor calculation for some or all of the gNBs/TRPs, etc.

The following provides examples of priority rule implementations, according to aspects of the disclosure. The priority rules described herein are not exhaustive, and multiple priority rules may be used in combination. Additionally, some priority rule information to implement priority rules may be determined by a server such as an OTT server and transmitted to the UE, while some may be determined by the UE.

In some aspects, a rule may prioritize one or more TRS groups to measure. For example, the priority rule information may indicate an order in which some or all of the twelve different TRS groups described above (combinations of symbol configuration and frequency offset) should be searched. In some cases, a UE may receive messaging indicating the TRS group priority rule information, while in some cases the UE may determine at least some priority rule information to generate a priority order or supplement a received priority order. The priority rule information may comprise a TRS group priority list that includes a search order of some or all TRS groups (e.g., a list of TRS groups using group numbers assigned to different combinations of symbol configuration and frequency offset, ordered from highest to lowest priority). The UE can use the TRS group priority list to perform a search process to measure downlink signals from a plurality of cells.

In some cases, an OTT server may determine priority order based at least in part on previously obtained information indicative of TRS groups being used by one or more cells/TRPs near the current location of the UE, based on information indicative of a particular operator associated with a cell/TRP near the current location of the UE, based on prevalence of a TRS group being used among operators, or a combination thereof. In some cases, a UE can determine at least some prioritization information based on one or more cells being a previous serving cell, based on TRS information from one or more other UEs (e.g., using device-to-device communication), etc.

In addition to obtaining enough downlink signal measurements to generate an early positioning fix in the event modem activity is initiated prior to completion of an OTT positioning process, the priority rule(s) may be implemented to balance power and processing use with positioning requirements even in the absence of scheduled modem activity. For example, a TRS group priority list may include fewer than all of the TRS groups in order to save power and processing at the UE, and/or enable faster completion of the positioning fix.

In some aspects, a rule may prioritize measurement of one or more of the receive chains. For example, a UE with four receive chains may receive messaging with priority rule information indicating which receive chain to select for an initial search. In another example, the UE may determine at least some prioritization information to generate a receive chain priority list or supplement a receive chain priority list from an OTT server. In some cases, the OTT server may provide a priority list including most or all of the receive chains, while in some cases the OTT server may omit one or more of the available receive chains in order to save power and processing at the UE. The receive chain priority list may be a list of receive chain identifiers in a search order, from higher priority to lower priority (if more than one receive chain is included). The UE can use the receive chain priority list to perform a search process to measure downlink signals from a plurality of cells.

In some aspects, a rule may prioritize one or more cells to measure within a TRS group. As noted above, there are 1024 scrambling IDs that can be associated with different cells, and an exhaustive blind search can be time consuming. For example, a UE may receive messaging indicating a cell priority list including a search order in which cell parameters (e.g., some or all of the 1024 scrambling IDs) should be searched. In some aspects, there may be a maximum number of cell searches per TRS group (for example, 64, 32, 20, 10, etc.). In another example, the UE may determine at least some prioritization information to generate the cell priority list or supplement a cell priority list from an OTT server. The UE can use the cell priority list to perform a search process to measure downlink signals from a plurality of cells.

In some aspects, a rule may prioritize one or more slot hypotheses for searching. As noted above, TRS may be configured in one or two slots, and the UE may receive messaging indicating a slot hypothesis option. For example, the UE may receive messaging indicating a slot hypothesis to search a first slot only, a second slot only, to search both slots using coherent combining, or to search both slots using non-coherent combining. The indication may be (for example) one or more flags/fields indicating the slot hypothesis, and for the two slot case may indicate coherent or non-coherent combining. The UE can use the indication of the slot hypothesis to perform a search process to measure downlink signals from a plurality of cells.

In some aspects, a rule may provide the option to do Doppler calculations to generate Doppler information. Doppler can affect the quality of measurements based on the difference in received versus transmitted frequency, which increases as the relative velocity between the transmitter and receiver increases. Additionally, there is generally some variation in phase and frequency from one slot to the next. Therefore, priority rule information may incorporate Doppler calculations to prioritize search for some cells over others by determining which cells may be associated with more or less Doppler. For example, the UE may receive messaging to perform Doppler calculations per cell, per TRS group, or per UE. In some cases, a Doppler-related rule may be used by the UE to prioritize search for a cell with lower Doppler over a cell with higher Doppler within a priority list (e.g., a cell priority list received from an OTT server).

In some aspects, a rule may provide interference cancelation (IC) iteration limits. Interference cancellation refers to analyzing a signal to estimate interference from sources other than the signal being measured, and based on the analysis cancelling the estimated interference. In some typical implementations, two to five IC iterations are performed to increase the effectiveness of the cancellation. However, since each IC iteration is time consuming, priority rule information may indicate that fewer IC iterations are to be performed. For example, the UE may receive messaging including priority rule information with a number of interference cancelation iterations to use in a search process to measure downlink signals from a plurality of cells (e.g., whether to perform one or two IC iterations rather than a larger number). The IC iterations may be based on the number of possible cells per receive chain, per TRS group, etc. In some cases, the OTT server may provide an upper limit on a number of cells to be found per TRS group (since multiple cells using the same TRS group may be associated with greater interference with an enhanced need for interference cancellation).

FIG. 13A illustrates crowdsourcing in an example OTT positioning environment 1300 with a plurality of UEs, cells/TRPs, and a location (OTT) server, according to some aspects of the disclosure. Each of the UEs is configured by the cell network with time, frequency, and scrambling ID to measure TRS from its current serving cell. For example, UEs 1310-A, 1310-B, and 1310-C receive configuration information to measure TRS from their current serving cell (cell 1320-A), while UE 1310-D receives configuration information to measure TRS from its current serving cell (cell 1320-B) and UE 1310-E receives configuration information to measure TRS from its current serving cell (cell 1320-C). As noted above, TRS is a type of Channel State Information used for time and frequency tracking, so from the network perspective a UE only needs configuration for its current serving cell. However, if each of the UEs in FIG. 13A is an OTT client, the configuration information can be sent to a location/OTT server 1330 in order to crowdsource TRS information for OTT positioning. Each of the UEs can transmit TRS configuration information to OTT server 1330 via its serving cell, enabling OTT server 1330 to crowdsource TRS information from each of the cells 1320-A, 1320-B, and 1320-C to be used in OTT positioning processes for UEs proximate to the cells.

FIG. 13B shows an example OTT positioning configuration 1350 for a UE 1310-F in communication with serving cell 1320-A, with cells 1320-B and 1320-C nearby. FIG. 14A shows example TRS configuration 1400 for serving cell 1320-A, while FIG. 14B shows an example TRS configuration 1425 for cell 1320-B and FIG. 14C shows an example TRS configuration 1435 for cell 1320-C.

Serving cell 1320-A is transmitting TRS on TRS group 0, in symbols 4 and 8, with a first frequency offset, on slots 0 and 1, as shown in FIG. 14A. UE 1310-F can inform OTT server 1330 of TRS configuration for cell 1320-A, or it may already have the configuration information based on previous crowdsourcing. OTT server 1330 also has crowdsourcing information that neighbor cell 1320-B is also transmitting TRS group 0 on slots 0 and 1, but in slot 1 is also transmitting downlink data on symbols other than 4 and 8 and across additional subcarriers, as shown in FIG. 14B. Similarly, OTT server 1330 has crowdsourcing information that neighbor cell 1320-C is transmitting TRS group 8, on symbols 5 and 9, with a different frequency offset, as shown in FIG. 14C. Based on crowdsourced information from UE 1310-F or a different UE, OTT server 1330 knows that neighbor cell 1320-C can transmit TRS on symbols 5 and 9, with a different frequency offset, which would experience interference from the data transmissions from cell 1320-B. In accordance with aspects of the disclosure, OTT server 1330 may send priority rule information indicating a slot hypothesis rule to measure TRS in slot 0 only (based on potential interference), and in the priority order of TRS group 0 and then TRS group 8.

As noted above, additional information may be used to generate the priority rule information. For example, if a data loading profile for one or more of the proximate gNBs indicates significant data loading in one or more symbols, the priority rule information may de-prioritize TRS detection for that symbol. DOP information (e.g., one or more DOP metrics) for a set of gNBs/TRPs can be used to increase the accuracy of a position fix (particularly an early position fix with fewer measurements than planned) by prioritizing TRS detection for TRPs associated with higher positioning accuracy/precision (e.g., a set of TRPs with lower DOP based on greater angular separation from the UE perspective). Other parameters affecting positioning quality may also be used to determine priority rule information. For example, multipath characteristics of some or all of the gNBs/TRPs (or LOS/NLOS characteristics) can increase the priority of gNBs/TRPs with less multipath (more LOS) or decrease the priority of gNBs/TRPs with more multipath. Similarly, gNBs/TRPs whose signals may be less affected by Doppler may be prioritized over signals more affected by Doppler. The consistency of downlink signal measurements (e.g., one or more variability metrics based on previous downlink signal measurements) or other parameter related to the history of downlink signal measurements may be used to determine priority rule information. In some cases, an operator identity for at least one cell may be used to determine priority rule information.

As noted above, the priority rule information may be generated by the UE, OTT server, or a combination. For example, a UE may receive priority rule information indicating a cell priority list indicating a search order of scrambling IDs from the OTT server. Based on one or more parameters such as multipath, Doppler, prior history of downlink signal measurements, and/or other parameters, the UE may modify the priority rule information to measure TRS signals in a different order (e.g., prioritizing a cell based on low multipath or deprioritizing a cell based on significant Doppler).

Although the foregoing uses TRS as a primary example, other signals and transmitter types may be used to transmit the downlink signals for OTT positioning. For example, other Channel State Information Resource Signals (CSI-RS), one or more signals included in a synchronization signal block (SSB), cell-specific reference signals (CRS), long training sequence signals (LTS), or a combination thereof may be used for OTT positioning. One or more UEs detecting the above signals may transmit downlink configuration information and associated transmitter identification information for the transmitter to an OTT server, and the OTT server or UE can generate priority rule information for measuring downlink signals and associating the signal measurements with the transmitter identifier (and thus the transmitter location) to calculate a position fix at the UE or the OTT server. The particular details of the priority rule information corresponds to the type of signals and transmitters used. For example, CRS is transmitted in every LTE subframe and on antenna ports 0, 1, 2, and 3, and is transmitted with a fixed time domain index and with a frequency domain index k that depends on the Physical Cell ID. The priority rule information may be used by a UE to measure one or more parameters of downlink CRS signals using the configuration characteristics of CRS, as well as some or all of the features discussed above (e.g., priority rule information related to interference cancellation, Doppler, cell parameter, receive chain, etc.)

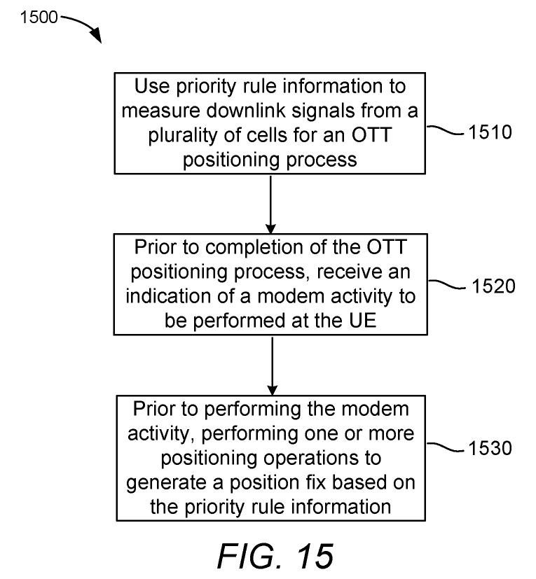

FIG. 15 illustrates an example method 1500 of OTT positioning, according to aspects of the disclosure. In an aspect, method 1500 may be performed by a UE (e.g., any of the UEs described herein).

At 1510, a UE may use priority rule information to measure downlink signals from a plurality of cells for an OTT positioning process. The priority rule information may be generated by an OTT server, by the UE, or a combination thereof.

In an aspect, operation 1510 may be performed by the one or more WWAN transceivers 310, the one or more short-range wireless transceivers 320, the one or more processors 342, memory 340, and/or positioning component(s) 348, any or all of which may be considered means (structure) for performing this operation.

At 1520, prior to completion of the OTT positioning process, the UE may receive an indication of a modem activity to be performed at the UE.

In an aspect, operation 1520 may be performed by the one or more WWAN transceivers 310, the one or more short-range wireless transceivers 320, the one or more processors 342, memory 340, and/or positioning component(s) 348, any or all of which may be considered means (structure) for performing this operation.

At 1530, prior to performing the modem activity, the UE may perform one or more positioning operations to generate a position fix based on the priority rule information. For example, the UE may calculate the position fix using the downlink signal measurements obtained using the priority rule information. In another example, the UE may transmit measurements of the downlink signals obtained using the priority rule information and an identifier of an associated transmitter of the downlink signals to an OTT server to calculate the position fix, transmit a notification of the modem activity to be performed at the UE to the OTT server, or a combination thereof.

In an aspect, operation 1530 may be performed by the one or more WWAN transceivers 310, the one or more short-range wireless transceivers 320, the one or more processors 342, memory 340, and/or positioning component(s) 348, any or all of which may be considered means (structure) for performing this operation.

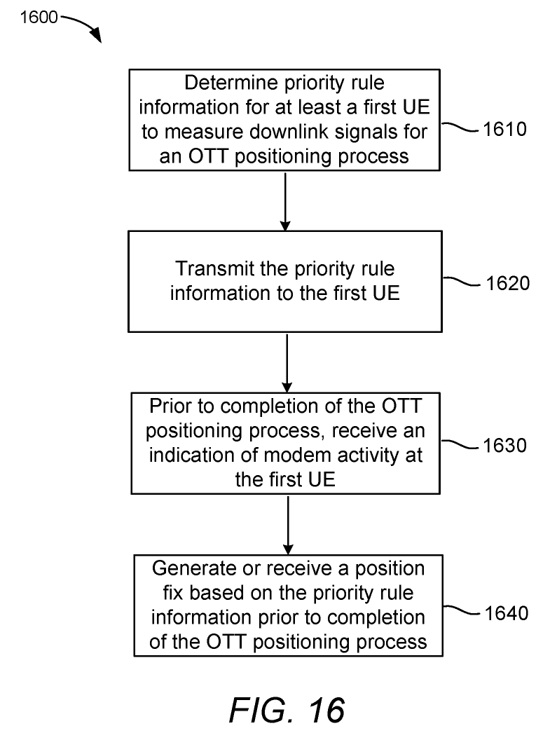

FIG. 16 illustrates an example method 1600 of OTT positioning, according to aspects of the disclosure. In an aspect, method 1600 may be performed by a network entity (e.g., a location server such as an OTT server or any of the network entities described herein).

At 1610, an OTT server may determine priority rule information for at least a first UE to measure downlink signals for an OTT positioning process. In an aspect, operation 1610 may be performed by the one or more network transceivers 390, the one or more processors 394, memory 396, and/or positioning component(s) 398, any or all of which may be considered means (structure) for performing this operation.

At 1620, the OTT server may transmit the priority rule information to the first UE. In an aspect, operation 1620 may be performed by the one or more network transceivers 390, the one or more processors 394, memory 396, and/or positioning component(s) 398, any or all of which may be considered means (structure) for performing this operation.

At 1630, prior to completion of the OTT positioning process, the OTT server may receive an indication of modem activity at the first UE. In an aspect, operation 1630 may be performed by the one or more network transceivers 390, the one or more processors 394, memory 396, and/or positioning component(s) 398, any or all of which may be considered means (structure) for performing this operation.

At 1640, the OTT server may generate or receive a position fix based on the priority rule information prior to completion of the OTT positioning process. In an aspect, operation 1640 may be performed by the one or more network transceivers 390, the one or more processors 394, memory 396, and/or positioning component(s) 398, any or all of which may be considered means (structure) for performing this operation.

As will be appreciated, a technical advantage of methods 1500 and 1600 is the ability to dynamically throttle OTT positioning using priority rule information in order to generate a position fix even in cases where a modem activity is initiated prior to completion of the positioning process. As a result, more efficient and reliable OTT positioning can be provided, with fewer missed or delayed position fixes. This can be particularly important for time-sensitive positioning use cases such as IIoT, robotics, and high precision device collaborations.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A method of over-the-top (OTT) positioning at a user equipment (UE), comprising: using priority rule information to measure downlink signals from a plurality of cells for an OTT positioning process; prior to completion of the OTT positioning process, receiving an indication of a modem activity to be performed at the UE; and prior to performing the modem activity, performing one or more positioning operations to generate a position fix based on the priority rule information.

Clause 2. The method of clause 1, wherein the priority rule information comprises a TRS group priority list including a search order of Tracking Reference Signal (TRS) groups and wherein using the priority rule information to measure downlink signals from a plurality of cells comprises performing a search process using the TRS group priority list.

Clause 3. The method of any of clauses 1 to 2, wherein the priority rule information comprises a receive chain priority list of one or more receive chains and wherein using the priority rule information to measure downlink signals from a plurality of cells comprises performing a search process using the receive chain priority list.

Clause 4. The method of any of clauses 1 to 3, wherein the priority rule information comprises a cell priority list including a search order of cell parameters, and wherein using the priority rule information to measure downlink signals from a plurality of cells comprises performing a search process using the cell priority list.

Clause 5. The method of any of clauses 1 to 4, wherein the priority rule information comprises an indication of one or more slot hypotheses to utilize to perform a search process to measure the downlink signals from the plurality of cells.

Clause 6. The method of any of clauses 1 to 5, wherein the modem activity to be performed at the UE comprises: one or more bandwidth part switching operations; one or more Radio Resource Control (RRC) reconfiguration operations; one or more handover operations; one or more emergency call operations; or a combination thereof.

Clause 7. The method of any of clauses 1 to 6, wherein the priority rule information comprises a number of interference cancelation iterations to use in a search process to measure the downlink signals from the plurality of cells.

Clause 8. The method of any of clauses 1 to 7, further comprising: receiving messaging including at least some of the priority rule information, determining at least some of the priority rule information at the UE, or a combination thereof.

Clause 9. The method of clause 8, wherein determining at least some of the priority rule information at the UE comprises determining the at least some of the priority rule information based on: one or more previous downlink signal measurements; variability of previous downlink signal measurements; previously received TRS configuration information for one or more neighbor cells; TRS configuration information for a current serving cell; Line of Sight (LOS) information, Non Line of Sight (NLOS) information or both associated with the current serving cell, one or more neighbor cells, or a combination thereof; multipath information associated with the current serving cell, one or more neighbor cells, or a combination thereof; Doppler information associated with the current serving cell, one or more neighbor cells, or a combination thereof; or a combination thereof.

Clause 10. The method of any of clauses 1 to 9, wherein the OTT positioning process is a Time of Arrival (ToA) or Time Difference of Arrival (TDoA) positioning process, and wherein the downlink signals comprise: TRS signals; other Channel State Information Resource Signals (CSI-RS); one or more signals included in a synchronization signal block (SSB); cell-specific reference signals (CRS); long training sequence signals (LTS); or a combination thereof.

Clause 11. The method of any of clauses 1 to 10, wherein performing the one or more positioning operations to generate the position fix comprises: transmitting measurements of the downlink signals from the plurality of cells and an identifier of an associated transmitter of the downlink signals to an OTT server to calculate the position fix, transmitting a notification of the modem activity to be performed at the UE, or a combination thereof.

Clause 12. The method of any of clauses 1 to 11, wherein performing the one or more positioning operations to generate the position fix comprises: generating the position fix at the UE using measurements of the downlink signals from the plurality of cells and position information for an associated transmitter of the downlink signals for each of the plurality of cells.

Clause 13. A method of over-the-top (OTT) positioning at an OTT server, comprising: determining priority rule information for at least a first user equipment (UE) to measure downlink signals for an OTT positioning process; transmitting the priority rule information to the first UE; prior to completion of the OTT positioning process, receiving an indication of modem activity at the first UE; and generating or receiving a position fix based on the priority rule information prior to completion of the OTT positioning process.

Clause 14. The method of clause 13, wherein the priority rule information includes at least a Tracking Reference Signal (TRS) group priority list including some or all of a set of allowable TRS groups with a search order.

Clause 15. The method of any of clauses 13 to 14, wherein the priority rule information includes a priority list of one or more receive chains.

Clause 16. The method of any of clauses 13 to 15, wherein the priority rule information comprises a priority list of one or more cells with a search order of scrambling identifiers associated with each of the one or more cells.

Clause 17. The method of any of clauses 13 to 16, wherein the priority rule information comprises a slot hypothesis for a first slot and a second slot, the slot hypothesis indicating a search of: the first slot; the second slot; a coherent combination of the first slot and the second slot; or a non-coherent combination of the first slot and the second slot.

Clause 18. The method of any of clauses 13 to 17, wherein the priority rule information is based at least in part on Doppler information.

Clause 19. The method of any of clauses 13 to 18, wherein the priority rule information comprises a number of interference cancelation iterations.

Clause 20. The method of any of clauses 13 to 19, wherein determining priority rule information for at least the first UE to measure downlink signals for the OTT positioning process comprises determining priority rule information based on: crowdsourced information received from the first UE, one or more other UEs, or a combination thereof; TRS configuration information for a current serving cell of the first UE, one or more neighbor cells of the first UE, or a combination thereof; data loading information for the current serving cell of the first UE, one or more neighbor cells of the first UE, or a combination thereof; dilution of precision information associated with the current serving cell of the first UE, one or more neighbor cells of the first UE, or a combination thereof; Line of Sight (LOS) information, Non-LOS information or both associated with the current serving cell of the first UE, one or more neighbor cells of the first UE, or a combination thereof; multipath information associated with the current serving cell of the first UE, one or more neighbor cells of the first UE, or a combination thereof; operator identity for the current serving cell of the first UE, one or more neighbor cells of the first UE, or a combination thereof; or a combination thereof.

Clause 21. The method of any of clauses 13 to 20, wherein initiating the OTT positioning process is a Time of Arrival (ToA) or Time Difference of Arrival (TDoA) positioning process, and wherein the indication of modem activity at the first UE comprises an explicit indication of the modem activity or an implicit indication of the modem activity.

Clause 22. The method of clause 21, wherein the implicit indication of modem activity comprises a request from the first UE to generate the position fix prior to completion of the OTT positioning process.

Clause 23. A user equipment (UE), comprising: one or more memories; one or more transceivers; and one or more processors communicatively coupled to the one or more memories and the one or more transceivers, wherein the one or more processors, either alone or in combination, are configured to: measure downlink signals from a plurality of cells for an over-the-top (OTT) positioning process using priority rule information; prior to completion of the OTT positioning process, receive an indication of a modem activity to be performed at the UE; and prior to performing the modem activity, perform one or more positioning operations to generate a position fix based on the priority rule information.

Clause 24. The user equipment of clause 23, wherein the priority rule information comprises a TRS group priority list including a search order of Tracking Reference Signal (TRS) groups and wherein the one or more processors, either alone or in combination, are configured to perform a search process using the TRS group priority list to measure the downlink signals from the plurality of cells.

Clause 25. The user equipment of any of clauses 23 to 24, wherein the priority rule information comprises a receive chain priority list of one or more receive chains and wherein the one or more processors, either alone or in combination, are configured to perform a search process using the receive chain priority list to measure the downlink signals from the plurality of cells.

Clause 26. The user equipment of any of clauses 23 to 25, wherein the priority rule information comprises a cell priority list including a search order of cell parameters, and wherein the one or more processors, either alone or in combination, are configured to perform a search process using the cell priority list to measure the downlink signals from the plurality of cells.

Clause 27. The user equipment of any of clauses 23 to 26, wherein the priority rule information comprises an indication of one or more slot hypotheses to utilize to perform a search process to measure the downlink signals from the plurality of cells.

Clause 28. The user equipment of any of clauses 23 to 27, wherein the modem activity to be performed at the UE comprises: one or more bandwidth part switching operations; one or more Radio Resource Control (RRC) reconfiguration operations; one or more handover operations; one or more emergency call operations; or a combination thereof.

Clause 29. The user equipment of any of clauses 23 to 28, wherein the priority rule information comprises a number of interference cancelation iterations to use in a search process to measure the downlink signals from the plurality of cells.

Clause 30. The user equipment of any of clauses 23 to 29, wherein the one or more processors, either alone or in combination, are further configured to: receive, via the one or more transceivers, messaging including at least some of the priority rule information; determine at least some of the priority rule information at the UE; or a combination thereof.

Clause 31. The user equipment of clause 30, wherein, to determine at least some of the priority rule information at the UE, the one or more processors, either alone or in combination, are configured to determine the at least some of the priority rule information based on: one or more previous downlink signal measurements; variability of previous downlink signal measurements; previously received TRS configuration information for one or more neighbor cells; TRS configuration information for a current serving cell; Line of Sight (LOS) information, Non Line of Sight (NLOS) information or both associated with the current serving cell, one or more neighbor cells, or a combination thereof; multipath information associated with the current serving cell, one or more neighbor cells, or a combination thereof; Doppler information associated with the current serving cell, one or more neighbor cells, or a combination thereof; or a combination thereof.

Clause 32. The user equipment of any of clauses 23 to 31, wherein the OTT positioning process is a Time of Arrival (ToA) or Time Difference of Arrival (TDoA) positioning process, and wherein the downlink signals comprise: TRS signals; other Channel State Information Resource Signals (CSI-RS); one or more signals included in a synchronization signal block (SSB); cell-specific reference signals (CRS); long training sequence signals (LTS); or a combination thereof.

Clause 33. The user equipment of any of clauses 23 to 32, wherein, to perform the one or more positioning operations to generate the position fix, the one or more processors, either alone or in combination, are configured to: transmit, via the one or more transceivers, measurements of the downlink signals from the plurality of cells and an identifier of an associated transmitter of the downlink signals to an OTT server to calculate the position fix, transmit a notification of the modem activity to be performed at the UE, or a combination thereof.

Clause 34. The user equipment of any of clauses 23 to 33, wherein, to perform the one or more positioning operations to generate the position fix, the one or more processors, either alone or in combination, are configured to: generate the position fix at the UE using measurements of the downlink signals from the plurality of cells and position information for an associated transmitter of the downlink signals for each of the plurality of cells.

Clause 35. An over-the-top (OTT) server, comprising: one or more memories; one or more transceivers; and one or more processors communicatively coupled to the one or more memories and the one or more transceivers, wherein the one or more processors, either alone or in combination, are configured to: determine priority rule information for at least a first user equipment (UE) to measure downlink signals for an OTT positioning process; transmit, via the one or more transceivers, the priority rule information to the first UE; prior to completion of the OTT positioning process, receive an indication of modem activity at the first UE; and generate or receive a position fix based on the priority rule information prior to completion of the OTT positioning process.

Clause 36. The OTT server of clause 35, wherein the priority rule information includes at least a Tracking Reference Signal (TRS) group priority list including some or all of a set of allowable TRS groups with a search order.

Clause 37. The OTT server of any of clauses 35 to 36, wherein the priority rule information includes a priority list of one or more receive chains.

Clause 38. The OTT server of any of clauses 35 to 37, wherein the priority rule information comprises a priority list of one or more cells with a search order of scrambling identifiers associated with each of the one or more cells.

Clause 39. The OTT server of any of clauses 35 to 38, wherein the priority rule information comprises a slot hypothesis for a first slot and a second slot, the slot hypothesis indicating a search of: the first slot; the second slot; a coherent combination of the first slot and the second slot; or a non-coherent combination of the first slot and the second slot.

Clause 40. The OTT server of any of clauses 35 to 39, wherein the priority rule information is based at least in part on Doppler information.

Clause 41. The OTT server of any of clauses 35 to 40, wherein the priority rule information comprises a number of interference cancelation iterations.

Clause 42. The OTT server of any of clauses 35 to 41, wherein, to determine priority rule information for at least the first UE to measure downlink signals for the OTT positioning process, the one or more processors, either alone or in combination, are configured to determine priority rule information based on: crowdsourced information received from the first UE, one or more other UEs, or a combination thereof; TRS configuration information for a current serving cell of the first UE, one or more neighbor cells of the first UE, or a combination thereof; data loading information for the current serving cell of the first UE, one or more neighbor cells of the first UE, or a combination thereof; dilution of precision information associated with the current serving cell of the first UE, one or more neighbor cells of the first UE, or a combination thereof; Line of Sight (LOS) information, Non-LOS information or both associated with the current serving cell of the first UE, one or more neighbor cells of the first UE, or a combination thereof; multipath information associated with the current serving cell of the first UE, one or more neighbor cells of the first UE, or a combination thereof; operator identity for the current serving cell of the first UE, one or more neighbor cells of the first UE, or a combination thereof; or a combination thereof.

Clause 43. The OTT server of any of clauses 35 to 42, wherein initiating the OTT positioning process is a Time of Arrival (ToA) or Time Difference of Arrival (TDoA) positioning process, and wherein the indication of modem activity at the first UE comprises an explicit indication of the modem activity or an implicit indication of the modem activity.

Clause 44. The OTT server of clause 43, wherein the implicit indication of modem activity comprises a request from the first UE to generate the position fix prior to completion of the OTT positioning process.

Clause 45. A user equipment (UE), comprising: means for using priority rule information to measure downlink signals from a plurality of cells for an over-the-top (OTT) positioning process; means for receiving an indication of a modem activity to be performed at the UE prior to completion of the OTT positioning process; and means for performing one or more positioning operations to generate a position fix based on the priority rule information prior to performing the modem activity.

Clause 46. The user equipment of clause 45, wherein the priority rule information comprises a TRS group priority list including a search order of Tracking Reference Signal (TRS) groups and wherein the means for using the priority rule information to measure downlink signals from a plurality of cells comprises means for performing a search process using the TRS group priority list.

Clause 47. The user equipment of any of clauses 45 to 46, wherein the priority rule information comprises a receive chain priority list of one or more receive chains and wherein the means for using the priority rule information to measure downlink signals from a plurality of cells comprises means for performing a search process using the receive chain priority list.

Clause 48. The user equipment of any of clauses 45 to 47, wherein the priority rule information comprises a cell priority list including a search order of cell parameters, and wherein the means for using the priority rule information to measure downlink signals from a plurality of cells comprises means for performing a search process using the cell priority list.

Clause 49. The user equipment of any of clauses 45 to 48, wherein the priority rule information comprises an indication of one or more slot hypotheses to utilize to perform a search process to measure the downlink signals from the plurality of cells.

Clause 50. The user equipment of any of clauses 45 to 49, wherein the modem activity to be performed at the UE comprises: one or more bandwidth part switching operations; one or more Radio Resource Control (RRC) reconfiguration operations; one or more handover operations; one or more emergency call operations; or a combination thereof.

Clause 51. The user equipment of any of clauses 45 to 50, wherein the priority rule information comprises a number of interference cancelation iterations to use in a search process to measure the downlink signals from the plurality of cells.

Clause 52. The user equipment of any of clauses 45 to 51, further comprising: means for receiving messaging including at least some of the priority rule information, means for determining at least some of the priority rule information at the UE, or a combination thereof.

Clause 53. The user equipment of clause 52, wherein the means for determining at least some of the priority rule information at the UE comprises means for determining the at least some of the priority rule information based on: one or more previous downlink signal measurements; variability of previous downlink signal measurements; previously received TRS configuration information for one or more neighbor cells; TRS configuration information for a current serving cell; Line of Sight (LOS) information, Non Line of Sight (NLOS) information or both associated with the current serving cell, one or more neighbor cells, or a combination thereof; multipath information associated with the current serving cell, one or more neighbor cells, or a combination thereof; Doppler information associated with the current serving cell, one or more neighbor cells, or a combination thereof; or a combination thereof.

Clause 54. The user equipment of any of clauses 45 to 53, wherein the OTT positioning process is a Time of Arrival (ToA) or Time Difference of Arrival (TDoA) positioning process, and wherein the downlink signals comprise: TRS signals; other Channel State Information Resource Signals (CSI-RS); one or more signals included in a synchronization signal block (SSB); cell-specific reference signals (CRS); long training sequence signals (LTS); or a combination thereof.

Clause 55. The user equipment of any of clauses 45 to 54, wherein the means for performing the one or more positioning operations to generate the position fix comprises: means for transmitting measurements of the downlink signals from the plurality of cells and an identifier of an associated transmitter of the downlink signals to an OTT server to calculate the position fix, means for transmitting a notification of the modem activity to be performed at the UE, or a combination thereof.

Clause 56. The user equipment of any of clauses 45 to 55, wherein the means for performing the one or more positioning operations to generate the position fix comprises: means for generating the position fix at the UE using measurements of the downlink signals from the plurality of cells and position information for an associated transmitter of the downlink signals for each of the plurality of cells.

Clause 57. An over-the-top (OTT) server, comprising: means for determining priority rule information for at least a first user equipment (UE) to measure downlink signals for an OTT positioning process; means for transmitting the priority rule information to the first UE; means for receiving an indication of modem activity at the first UE prior to completion of the OTT positioning process; and means for generating or receiving a position fix based on the priority rule information prior to completion of the OTT positioning process.

Clause 58. The OTT server of clause 57, wherein the priority rule information includes at least a Tracking Reference Signal (TRS) group priority list including some or all of a set of allowable TRS groups with a search order.

Clause 59. The OTT server of any of clauses 57 to 58, wherein the priority rule information includes a priority list of one or more receive chains.

Clause 60. The OTT server of any of clauses 57 to 59, wherein the priority rule information comprises a priority list of one or more cells with a search order of scrambling identifiers associated with each of the one or more cells.

Clause 61. The OTT server of any of clauses 57 to 60, wherein the priority rule information comprises a slot hypothesis for a first slot and a second slot, the slot hypothesis indicating a search of: the first slot; the second slot; a coherent combination of the first slot and the second slot; or a non-coherent combination of the first slot and the second slot.

Clause 62. The OTT server of any of clauses 57 to 61, wherein the priority rule information is based at least in part on Doppler information.

Clause 63. The OTT server of any of clauses 57 to 62, wherein the priority rule information comprises a number of interference cancelation iterations.

Clause 64. The OTT server of any of clauses 57 to 63, wherein the means for determining priority rule information for at least the first UE to measure downlink signals for the OTT positioning process comprises means for determining priority rule information based on: crowdsourced information received from the first UE, one or more other UEs, or a combination thereof; TRS configuration information for a current serving cell of the first UE, one or more neighbor cells of the first UE, or a combination thereof; data loading information for the current serving cell of the first UE, one or more neighbor cells of the first UE, or a combination thereof; dilution of precision information associated with the current serving cell of the first UE, one or more neighbor cells of the first UE, or a combination thereof; Line of Sight (LOS) information, Non-LOS information or both associated with the current serving cell of the first UE, one or more neighbor cells of the first UE, or a combination thereof; multipath information associated with the current serving cell of the first UE, one or more neighbor cells of the first UE, or a combination thereof; operator identity for the current serving cell of the first UE, one or more neighbor cells of the first UE, or a combination thereof; or a combination thereof.

Clause 65. The OTT server of any of clauses 57 to 64, wherein the OTT positioning process is a Time of Arrival (ToA) or Time Difference of Arrival (TDoA) positioning process, and wherein the indication of modem activity at the first UE comprises an explicit indication of the modem activity or an implicit indication of the modem activity.

Clause 66. The OTT server of clause 65, wherein the implicit indication of modem activity comprises a request from the first UE to generate the position fix prior to completion of the OTT positioning process.

Clause 67. A non-transitory computer-readable medium storing computer-executable instructions that, when executed by a user equipment (UE), cause the user equipment to: use priority rule information to measure downlink signals from a plurality of cells for an over-the-top (OTT) positioning process; prior to completion of the OTT positioning process, receive an indication of a modem activity to be performed at the UE; and prior to performing the modem activity, perform one or more positioning operations to generate a position fix based on the priority rule information.

Clause 68. The non-transitory computer-readable medium of clause 67, wherein the priority rule information comprises a TRS group priority list including a search order of Tracking Reference Signal (TRS) groups and wherein using the priority rule information to measure downlink signals from a plurality of cells comprises performing a search process using the TRS group priority list.

Clause 69. The non-transitory computer-readable medium of any of clauses 67 to 68, wherein the priority rule information comprises a receive chain priority list of one or more receive chains and wherein using the priority rule information to measure downlink signals from a plurality of cells comprises performing a search process using the receive chain priority list.

Clause 70. The non-transitory computer-readable medium of any of clauses 67 to 69, wherein the priority rule information comprises a cell priority list including a search order of cell parameters, and wherein using the priority rule information to measure downlink signals from a plurality of cells comprises performing a search process using the cell priority list.

Clause 71. The non-transitory computer-readable medium of any of clauses 67 to 70, wherein the priority rule information comprises an indication of one or more slot hypotheses to utilize to perform a search process to measure the downlink signals from the plurality of cells.

Clause 72. The non-transitory computer-readable medium of any of clauses 67 to 71, wherein the modem activity to be performed at the UE comprises: one or more bandwidth part switching operations; one or more Radio Resource Control (RRC) reconfiguration operations; one or more handover operations; one or more emergency call operations; or a combination thereof.

Clause 73. The non-transitory computer-readable medium of any of clauses 67 to 72, wherein the priority rule information comprises a number of interference cancelation iterations to use in a search process to measure the downlink signals from the plurality of cells.

Clause 74. The non-transitory computer-readable medium of any of clauses 67 to 73, further comprising computer-executable instructions that, when executed by the user equipment, cause the user equipment to: receive messaging including at least some of the priority rule information, determine at least some of the priority rule information at the UE, or a combination thereof.

Clause 75. The non-transitory computer-readable medium of clause 74, wherein the computer-executable instructions that, when executed by the user equipment, cause the user equipment to determine at least some of the priority rule information at the UE comprise computer-executable instructions that, when executed by the user equipment, cause the user equipment to determine the at least some of the priority rule information based on: one or more previous downlink signal measurements; variability of previous downlink signal measurements; previously received TRS configuration information for one or more neighbor cells; TRS configuration information for a current serving cell; Line of Sight (LOS) information, Non Line of Sight (NLOS) information or both associated with the current serving cell, one or more neighbor cells, or a combination thereof; multipath information associated with the current serving cell, one or more neighbor cells, or a combination thereof; Doppler information associated with the current serving cell, one or more neighbor cells, or a combination thereof; or a combination thereof.

Clause 76. The non-transitory computer-readable medium of any of clauses 67 to 75, wherein the OTT positioning process is a Time of Arrival (ToA) or Time Difference of Arrival (TDoA) positioning process, and wherein the downlink signals comprise: TRS signals; other Channel State Information Resource Signals (CSI-RS); one or more signals included in a synchronization signal block (SSB); cell-specific reference signals (CRS); long training sequence signals (LTS); or a combination thereof.

Clause 77. The non-transitory computer-readable medium of any of clauses 67 to 76, wherein the computer-executable instructions that, when executed by the user equipment, cause the user equipment to perform the one or more positioning operations to generate the position fix comprise computer-executable instructions that, when executed by the user equipment, cause the user equipment to: transmit measurements of the downlink signals from the plurality of cells and an identifier of an associated transmitter of the downlink signals to an OTT server to calculate the position fix, transmitting a notification of the modem activity to be performed at the UE, or a combination thereof.

Clause 78. The non-transitory computer-readable medium of any of clauses 67 to 77, wherein the computer-executable instructions that, when executed by the user equipment, cause the user equipment to perform the one or more positioning operations to generate the position fix comprise computer-executable instructions that, when executed by the user equipment, cause the user equipment to: generate the position fix at the UE using measurements of the downlink signals from the plurality of cells and position information for an associated transmitter of the downlink signals for each of the plurality of cells.

Clause 79. A non-transitory computer-readable medium storing computer-executable instructions that, when executed by an over-the-top (OTT) server, cause the OTT server to: determine priority rule information for at least a first user equipment (UE) to measure downlink signals for an OTT positioning process; transmit the priority rule information to the first UE; prior to completion of the OTT positioning process, receive an indication of modem activity at the first UE; and generate or receive a position fix based on the priority rule information prior to completion of the OTT positioning process.

Clause 80. The non-transitory computer-readable medium of clause 79, wherein the priority rule information includes at least a Tracking Reference Signal (TRS) group priority list including some or all of a set of allowable TRS groups with a search order.

Clause 81. The non-transitory computer-readable medium of any of clauses 79 to 80, wherein the priority rule information includes a priority list of one or more receive chains.

Clause 82. The non-transitory computer-readable medium of any of clauses 79 to 81, wherein the priority rule information comprises a priority list of one or more cells with a search order of scrambling identifiers associated with each of the one or more cells.

Clause 83. The non-transitory computer-readable medium of any of clauses 79 to 82, wherein the priority rule information comprises a slot hypothesis for a first slot and a second slot, the slot hypothesis indicating a search of: the first slot; the second slot; a coherent combination of the first slot and the second slot; or a non-coherent combination of the first slot and the second slot.

Clause 84. The non-transitory computer-readable medium of any of clauses 79 to 83, wherein the priority rule information is based at least in part on Doppler information.

Clause 85. The non-transitory computer-readable medium of any of clauses 79 to 84, wherein the priority rule information comprises a number of interference cancelation iterations.

Clause 86. The non-transitory computer-readable medium of any of clauses 79 to 85, wherein the computer-executable instructions that, when executed by the OTT server, cause the OTT server to determine priority rule information for at least the first UE to measure downlink signals for the OTT positioning process comprise computer-executable instructions that, when executed by the OTT server, cause the OTT server to determine priority rule information based on: crowdsourced information received from the first UE, one or more other UEs, or a combination thereof; TRS configuration information for a current serving cell of the first UE, one or more neighbor cells of the first UE, or a combination thereof; data loading information for the current serving cell of the first UE, one or more neighbor cells of the first UE, or a combination thereof; dilution of precision information associated with the current serving cell of the first UE, one or more neighbor cells of the first UE, or a combination thereof; Line of Sight (LOS) information, Non-LOS information or both associated with the current serving cell of the first UE, one or more neighbor cells of the first UE, or a combination thereof; multipath information associated with the current serving cell of the first UE, one or more neighbor cells of the first UE, or a combination thereof; operator identity for the current serving cell of the first UE, one or more neighbor cells of the first UE, or a combination thereof; or a combination thereof.

Clause 87. The non-transitory computer-readable medium of any of clauses 79 to 86, wherein initiating the OTT positioning process is a Time of Arrival (ToA) or Time Difference of Arrival (TDoA) positioning process, and wherein the indication of modem activity at the first UE comprises an explicit indication of the modem activity or an implicit indication of the modem activity.

Clause 88. The non-transitory computer-readable medium of clause 87, wherein the implicit indication of modem activity comprises a request from the first UE to generate the position fix prior to completion of the OTT positioning process.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. For example, the functions, steps and/or actions of the method claims in accordance with the aspects of the disclosure described herein need not be performed in any particular order. Further, no component, function, action, or instruction described or claimed herein should be construed as critical or essential unless explicitly described as such. Furthermore, as used herein, the terms “set,” “group,” and the like are intended to include one or more of the stated elements. Also, as used herein, the terms “has,” “have,” “having,” “comprises,” “comprising,” “includes,” “including,” and the like does not preclude the presence of one or more additional elements (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”) or the alternatives are mutually exclusive (e.g., “one or more” should not be interpreted as “one and more”). Furthermore, although components, functions, actions, and instructions may be described or claimed in the singular, the plural is contemplated unless limitation to the singular is explicitly stated. Accordingly, as used herein, the articles “a,” “an,” “the,” and “said” are intended to include one or more of the stated elements. Additionally, as used herein, the terms “at least one” and “one or more” encompass “one” component, function, action, or instruction performing or capable of performing a described or claimed functionality and also “two or more” components, functions, actions, or instructions performing or capable of performing a described or claimed functionality in combination.

What is claimed is:

1. A user equipment (UE), comprising:
one or more memories;
one or more transceivers; and
one or more processors communicatively coupled to the one or more memories and the one or more transceivers, wherein the one or more processors, either alone or in combination, are configured to:
measure downlink signals from a plurality of cells for an over-the-top (OTT) positioning process using priority rule information;
prior to completion of the OTT positioning process, receive an indication of a modem activity to be performed at the UE; and
prior to performing the modem activity, perform one or more positioning operations to generate a position fix based on the priority rule information.

2. The user equipment of claim 1, wherein the priority rule information comprises a TRS group priority list including a search order of Tracking Reference Signal (TRS) groups and wherein the one or more processors, either alone or in combination, are configured to perform a search process using the TRS group priority list to measure the downlink signals from the plurality of cells.

3. The user equipment of claim 1, wherein the priority rule information comprises a receive chain priority list of one or more receive chains and wherein the one or more processors, either alone or in combination, are configured to perform a search process using the receive chain priority list to measure the downlink signals from the plurality of cells.

4. The user equipment of claim 1, wherein the priority rule information comprises a cell priority list including a search order of cell parameters, and wherein the one or more processors, either alone or in combination, are configured to perform a search process using the cell priority list to measure the downlink signals from the plurality of cells.

5. The user equipment of claim 1, wherein the priority rule information comprises an indication of one or more slot hypotheses to utilize to perform a search process to measure the downlink signals from the plurality of cells.

6. The user equipment of claim 1, wherein the modem activity to be performed at the UE comprises:
one or more bandwidth part switching operations;
one or more Radio Resource Control (RRC) reconfiguration operations;
one or more handover operations;
one or more emergency call operations; or
a combination thereof.

7. The user equipment of claim 1, wherein the priority rule information comprises a number of interference cancelation iterations to use in a search process to measure the downlink signals from the plurality of cells.

8. The user equipment of claim 1, wherein the one or more processors, either alone or in combination, are further configured to:
receive, via the one or more transceivers, messaging including at least some of the priority rule information;
determine at least some of the priority rule information at the UE; or
a combination thereof.

9. The user equipment of claim 8, wherein, to determine at least some of the priority rule information at the UE, the one or more processors, either alone or in combination, are configured to determine the at least some of the priority rule information based on:
one or more previous downlink signal measurements;
variability of previous downlink signal measurements;
previously received TRS configuration information for one or more neighbor cells;
TRS configuration information for a current serving cell;
Line of Sight (LOS) information, Non Line of Sight (NLOS) information or both associated with the current serving cell, one or more neighbor cells, or a combination thereof;
multipath information associated with the current serving cell, one or more neighbor cells, or a combination thereof;
Doppler information associated with the current serving cell, one or more neighbor cells, or a combination thereof; or
a combination thereof.

10. The user equipment of claim 1, wherein the OTT positioning process is a Time of Arrival (ToA) or Time Difference of Arrival (TDoA) positioning process, and wherein the downlink signals comprise:
TRS signals;
other Channel State Information Resource Signals (CSI-RS);
one or more signals included in a synchronization signal block (SSB);
cell-specific reference signals (CRS);
long training sequence signals (LTS); or
a combination thereof.

11. The user equipment of claim 1, wherein, to perform the one or more positioning operations to generate the position fix, the one or more processors, either alone or in combination, are configured to:
transmit, via the one or more transceivers, measurements of the downlink signals from the plurality of cells and an identifier of an associated transmitter of the downlink signals to an OTT server to calculate the position fix, transmit a notification of the modem activity to be performed at the UE, or a combination thereof.

12. The user equipment of claim 1, wherein, to perform the one or more positioning operations to generate the position fix, the one or more processors, either alone or in combination, are configured to:
generate the position fix at the UE using measurements of the downlink signals from the plurality of cells and position information for an associated transmitter of the downlink signals for each of the plurality of cells.

13. An over-the-top (OTT) server, comprising:
one or more memories;
one or more transceivers; and
one or more processors communicatively coupled to the one or more memories and the one or more transceivers, wherein the one or more processors, either alone or in combination, are configured to:
determine priority rule information for at least a first UE to measure downlink signals for an OTT positioning process;
transmit, via the one or more transceivers, the priority rule information to the first UE;
prior to completion of the OTT positioning process, receive an indication of modem activity at the first UE; and
generate or receive a position fix based on the priority rule information prior to completion of the OTT positioning process.

14. The OTT server of claim 13, wherein the priority rule information includes at least a Tracking Reference Signal (TRS) group priority list including some or all of a set of allowable TRS groups with a search order.

15. The OTT server of claim 13, wherein the priority rule information includes a priority list of one or more receive chains.

16. The OTT server of claim 13, wherein the priority rule information comprises a priority list of one or more cells with a search order of scrambling identifiers associated with each of the one or more cells.

17. The OTT server of claim 13, wherein the priority rule information comprises a slot hypothesis for a first slot and a second slot, the slot hypothesis indicating a search of:
the first slot;
the second slot;
a coherent combination of the first slot and the second slot; or
a non-coherent combination of the first slot and the second slot.

18. The OTT server of claim 13, wherein the priority rule information is based at least in part on Doppler information.

19. The OTT server of claim 13, wherein the priority rule information comprises a number of interference cancelation iterations.

20. The OTT server of claim 13, wherein, to determine priority rule information for at least the first UE to measure downlink signals for the OTT positioning process, the one or more processors, either alone or in combination, are configured to determine priority rule information based on:
crowdsourced information received from the first UE, one or more other UEs, or a combination thereof;
TRS configuration information for a current serving cell of the first UE, one or more neighbor cells of the first UE, or a combination thereof;
data loading information for the current serving cell of the first UE, one or more neighbor cells of the first UE, or a combination thereof;
dilution of precision information associated with the current serving cell of the first UE, one or more neighbor cells of the first UE, or a combination thereof;
Line of Sight (LOS) information, Non-LOS information or both associated with the current serving cell of the first UE, one or more neighbor cells of the first UE, or a combination thereof;
multipath information associated with the current serving cell of the first UE, one or more neighbor cells of the first UE, or a combination thereof;
operator identity for the current serving cell of the first UE, one or more neighbor cells of the first UE, or a combination thereof; or
a combination thereof.

21. The OTT server of claim 13, wherein initiating the OTT positioning process is a Time of Arrival (ToA) or Time Difference of Arrival (TDoA) positioning process, and wherein the indication of modem activity at the first UE comprises an explicit indication of the modem activity or an implicit indication of the modem activity.

22. The OTT server of claim 21, wherein the implicit indication of modem activity comprises a request from the first UE to generate the position fix prior to completion of the OTT positioning process.

23. A method of over-the-top (OTT) positioning at a user equipment (UE), comprising:
using priority rule information to measure downlink signals from a plurality of cells for an OTT positioning process;
prior to completion of the OTT positioning process, receiving an indication of a modem activity to be performed at the UE; and
prior to performing the modem activity, performing one or more positioning operations to generate a position fix based on the priority rule information.

24. The method of claim 23, wherein the priority rule information comprises a TRS group priority list including a search order of Tracking Reference Signal (TRS) groups and wherein using the priority rule information to measure downlink signals from a plurality of cells comprises performing a search process using the TRS group priority list.

25. The method of claim 23, wherein the priority rule information comprises a receive chain priority list of one or more receive chains and wherein using the priority rule information to measure downlink signals from a plurality of cells comprises performing a search process using the receive chain priority list.

26. The method of claim 23, wherein the priority rule information comprises a cell priority list including a search order of cell parameters, and wherein using the priority rule information to measure downlink signals from a plurality of cells comprises performing a search process using the cell priority list.

27. The method of claim 23, wherein the priority rule information comprises an indication of one or more slot hypotheses to utilize to perform a search process to measure the downlink signals from the plurality of cells.

28. The method of claim 23, wherein the priority rule information comprises a number of interference cancelation iterations to use in a search process to measure the downlink signals from the plurality of cells.

29. A method of over-the-top (OTT) positioning at an OTT server, comprising:
determining priority rule information for at least a first user equipment (UE) to measure downlink signals for an OTT positioning process;
transmitting the priority rule information to the first UE;
prior to completion of the OTT positioning process, receiving an indication of modem activity at the first UE; and
generating or receiving a position fix based on the priority rule information prior to completion of the OTT positioning process.

30. The method of claim 29, wherein the priority rule information includes at least a Tracking Reference Signal (TRS) group priority list including some or all of a set of allowable TRS groups with a search order.
